(19) United States
(12) Patent Application Publication
(10) Pub. No.: US 2025/0065574 A1
(43) Pub. Date: Feb. 27, 2025

(54) METHOD FOR MANUFACTURING BUMPER REINFORCEMENT

(71) Applicant: RESONAC CORPORATION, Minato-ku, Tokyo (JP)

(72) Inventors: Nobuyuki TAKAHASHI, Tokyo (JP); Masahiro SATO, Tokyo (JP); Hayato SAITO, Tokyo (JP)

(73) Assignee: Resonac Corporation, Tokyo (JP)

(21) Appl. No.: 18/723,316

(22) PCT Filed: Nov. 28, 2022
(86) PCT No.: PCT/JP2022/043793

§ 371 Date: Jun. 24, 2024

(30) Foreign Application Priority Data
Dec. 27, 2021 (JP) 2021-212611

(51) Int. Cl. B29C 65/00; B29C 65/02; B29K 101/12; B29K 705/02; B29L 31/30; B60R 19/03; B60R 19/04

(52) U.S. Cl. CPC B29C 66/7422; B29C 65/02; B29K 2101/12; B29K 2705/02; B29K 2995/0039; B29K 2995/0077; B29L 2031/3044; B60R 19/03; B60R 19/04

(57) ABSTRACT

Provided is a method for manufacturing a bumper reinforcement in which bonding process time is short and open time is long. A method for manufacturing a bumper reinforcement of one embodiment includes: a pre-bonding step of preparing a layered body containing, in the following order, a metal member, which is a body section, a solid adhesive mainly comprising an amorphous thermoplastic resin that is at least one of a thermoplastic epoxy resin and a phenoxy resin, and a resin member, which is a resin reinforcement; and a bonding step of heating and pressurizing the layered body to melt the solid adhesive, and bonding the metal member and the resin member. Either the epoxy equivalent of the amorphous thermoplastic resin is 1,600 or more or the amorphous thermoplastic resin does not contain epoxy groups, and the heat of fusion of the amorphous thermoplastic resin is 15 J/g or less.

### TECHNICAL FIELD

The present disclosure relates to a method for producing a bumper reinforcement.

### BACKGROUND ART

A bumper structure is attached to each of a front portion and a rear portion of an automobile to protect a vehicle body and an occupant space by absorbing energy at the time of collision from the outside. As illustrated in FIG. 11, the bumper structure generally includes a bumper fascia 10, an energy absorber 20, a bumper reinforcement 30, a crash box 40, and a vehicle body fixing member 50 in this order from the outside.

PTL 1 (JP 2020-019307 A) describes a bumper reinforcement including: a metal body having a pair of vertical walls disposed to face each other; a reinforcing member formed in a sheet shape using a fiber-reinforced resin and disposed on a surface of one of the vertical walls opposite to the other of the vertical walls; and an adhesive layer provided between the one of the vertical walls and the reinforcing member to join them and formed in such a manner that a thickness in a vehicle front-rear direction of a portion disposed on an outer side in a plane direction of an outer end portion in the plane direction of the reinforcing member becomes thinner toward the outer side in the plane direction.

PTL 2 (JP 2019-209767 A) describes a vehicle structure such as a bumper including: a first member formed of a fiber-reinforced resin including a knitted fabric formed by knitting fibers and a matrix resin and having a groove-shaped cross section opening in a first direction; and a second member formed of a metal member, disposed in the first direction relative to the first member, and joined to the first member, in which the first member is disposed on the vehicle outer side relative to the second member.

### CITATION LIST

### Patent Literature

PTL 1: JP 2020-019307 A
PTL 2: JP 2019-209767 A

### SUMMARY OF INVENTION

### Technical Problem

Weight reduction in portions away from the center of gravity of an automobile, such as a front portion and a rear portion of the automobile, can improve running stability in addition to a fuel efficiency improvement effect. Thus, weight reduction in such portions is strongly desired as compared with other portions of the vehicle.

For a load at the time of collision, a bumper reinforcement disposed at each of the front and rear portions of the automobile is required to have high rigidity against a light load and to be plastically deformed against a heavy load to absorb an energy to a high degree. As illustrated in FIG. 12, when a heavy load W is applied, if a bumper reinforcement 30 is not plastically deformed and is broken or plastically deformed too much, a crash box 40 disposed on the vehicle body side is not crushed, so that the crash box 40 cannot absorb an impact energy. As a result, a bumper structure cannot efficiently absorb the energy at the time of collision from the outside, and thus, there is a possibility that a vehicle body and an occupant space cannot be sufficiently protected.

As illustrated in FIG. 11, the bumper reinforcement 30 is an elongated member extending along a vehicle width direction (±y direction in FIG. 11), and is generally formed using a metal material such as aluminum or iron. The bumper reinforcement made of metal has a hollow structure to reduce its weight. However, in the bumper reinforcement of a hollow structure having a cross-sectional shape for exhibiting the above-described performance, the weight reduction is insufficient.

The bumper reinforcement formed using a resin material is lighter than a bumper reinforcement formed using a metal material. However, the bumper reinforcement made of a resin is not easily plastically deformed and has insufficient rigidity, and thus, it is difficult to sufficiently exhibit the above-described performance.

Even in the bumper reinforcement described in PTLs 1 and 2 formed using a metal material and a resin material, it is difficult to sufficiently exhibit the above-described performance.

In the bumper reinforcement, a metal member containing a metal material and a resin member containing a resin material are fastened to each other using a bolt or the like, or are joined to each other by welding or adhesion using an adhesive.

As means for firmly joining dissimilar materials such as a metal member and a resin member, there are known a liquid or B-stage thermosetting epoxy resin-based adhesive and a hot melt adhesive containing a thermoplastic resin.

However, the thermosetting epoxy resin-based adhesive having excellent adhesiveness has a long joining process time or a short open time regardless of whether it is in a liquid form or in a B-stage form. The hot melt adhesive having a short joining process time and a long open time cannot stably provide a high adhesive force.

In the present disclosure, the joining process time means a time from a start point to an end point, the start point being a time point of contact between at least one of base materials constituting a joined body and a joining agent, and the end point being a time point of completion of preparation of the joined body. For example, the joining process time includes a time required for application and drying of a liquid adhesive or placement of a solid joining agent, and a time required for bonding base materials to each other (for example, curing an adhesive layer). When the joining process time is shorter, productivity of the joined body can be increased.

In the present disclosure, the open time means a time limit from when the joining agent is applied or placed on a base material A to when placement of a base material B is completed. Within the open time, the adhesive force of the joining agent is not decreased, and the base material A and the base material B can be bonded to each other with a sufficient adhesive force. When the open time is longer, the degree of freedom of production of the joined body can be enhanced.

The present disclosure has been made in view of the above-described technical background, and an object of the present disclosure is to provide a method for producing a bumper reinforcement having a short joining process time and a long open time when producing a lightweight bumper reinforcement that exhibits high rigidity against a light load and is plastically deformed against a heavy load to absorb a collision energy while effectively transmitting an unabsorbed energy to a crash box, for a load at the time of collision.

### Solution to Problem

The present disclosure includes the following aspects.

[1]

A method for producing a bumper reinforcement, the method including:
a pre-joining process of preparing a laminate in a state in which a metal member, a solid joining agent containing, as a main component, an amorphous thermoplastic resin which is at least one of a thermoplastic epoxy resin or a phenoxy resin, and a resin member to be joined to the metal member are arranged in this order; and
a joining process of melting the solid joining agent by heating and pressurizing the laminate to join the metal member and the resin member, wherein
the metal member is a body extending along a vehicle width direction and including at least one first joining portion on a vehicle body side,
the resin member is a resin reinforcing portion extending along the vehicle width direction and including at least one second joining portion,
the first joining portion of the body and the second joining portion of the resin member are joined to each other via the solid joining agent,
the resin reinforcing portion is disposed closer to a vehicle body than the body,
the resin reinforcing portion includes one or more reinforcing ribs that protrude toward the vehicle body and extend along the vehicle width direction, and
the amorphous thermoplastic resin has an epoxy equivalent of 1600 or more, or contains no epoxy group, and the amorphous thermoplastic resin has a heat of fusion of 15 J/g or less.
   [2]

The method for producing a bumper reinforcement according to [1], wherein the heating and pressurizing are performed under conditions of 100 to 400° C. and 0.01 to 20 MPa.

[3]

The method for producing a bumper reinforcement according to [1] or [2], wherein the solid joining agent before melting has a shape selected from the group consisting of a film, a rod, a pellet, and a powder.

[4]

The method for producing a bumper reinforcement according to any one of [1] to [3], wherein the body has an open cross section, and the first joining portion of the body and the second joining portion of the resin reinforcing portion are joined to each other to form a hollow portion inside the body.

[5]

The method for producing a bumper reinforcement according to any one of [1] to [4], wherein a cross-sectional shape of the body is a hat form.

[6]

The method for producing a bumper reinforcement according to any one of [1] to [5], wherein the body includes the first joining portion on each of upper and lower sides of the body, and the reinforcing rib is disposed corresponding to the first joining portion.

[7]

The method for producing a bumper reinforcement according to any one of [1] to [6], wherein the resin reinforcing portion includes one or more holes.

[8]

The method for producing a bumper reinforcement according to any one of [1] to [7], wherein the body includes an aluminum alloy having a tensile strength of 350 MPa or higher.

[9]

The method for producing a bumper reinforcement according to any one of [1] to [8], wherein the resin reinforcing portion includes a resin having an elastic modulus of 5 GPa or more at 80° C.

[10]

The method for producing a bumper reinforcement according to any one of [1] to [9], wherein the body includes the first joining portion on each of upper and lower sides of the body, and the resin reinforcing portion includes
a resin main body extending in the vehicle width direction, and
the second joining portion on each of upper and lower sides of the resin main body, and
the first joining portion and the second joining portion are joined at a joined surface that intersects a vehicle front-rear direction.
   [11]

The method for producing a bumper reinforcement according to any one of [1] to [10], wherein the resin reinforcing portion includes a second reinforcing rib extending in a vehicle up-down direction.

### Advantageous Effects of Invention

According to the production method of the present disclosure, it is possible to produce, in a short joining process time and a long open time, a lightweight bumper reinforcement that can exhibit high rigidity against a light load and can be plastically deformed against a heavy load to absorb a collision energy while effectively transmitting an unabsorbed energy to a crash box, for a load at the time of collision. In the present disclosure, materials, members, and structures having such rigidity and plastic deformation may be referred to as “appropriate rigidity” and “appropriate plastic deformation”.

### BRIEF DESCRIPTION OF DRAWINGS

FIG. 1 is a schematic perspective view of a bumper reinforcement according to an embodiment.

FIG. 2 is a schematic perspective view of a body of the embodiment.

FIG. 3 is a schematic perspective view of a resin reinforcing portion according to the embodiment.

FIG. 4 is a cross-sectional view taken along line A-A of FIG. 1.

FIG. 5 is a cross-sectional view relating to dimensions of a body 200 and a resin reinforcing portion 300 according to the embodiment.

FIG. 6 is a cross-sectional view of a bumper reinforcement according to another embodiment.

FIG. 7 is a cross-sectional view relating to dimensions of a body 500 and a resin reinforcing portion 600 according to another embodiment.

FIG. 8 is a schematic perspective view of a bumper reinforcement according to still another embodiment.

FIG. 9 is a schematic perspective view of a body side surface of a resin reinforcing portion 800 according to still another embodiment.

FIG. 10 is a schematic view of an evaluation apparatus in a three-point bending test.

FIG. 11 is a schematic perspective view illustrating a bumper structure of a vehicle.

FIG. 12 is a schematic view when an impact load is applied to a fragile bumper reinforcement disposed on a crash box.

FIG. 13 is a schematic view when an impact load is applied to a bumper reinforcement of an embodiment disposed on the crash box.

FIG. 14 is a schematic cross-sectional view of a state in which a metal member and a resin member are joined to each other via an adhesive layer containing a solid joining agent.

### DESCRIPTION OF EMBODIMENTS

Hereinafter, embodiments of the present disclosure will be described in detail with reference to the drawings. The present disclosure is not limited to the following embodiments, and can be variously modified within the scope of the present invention.

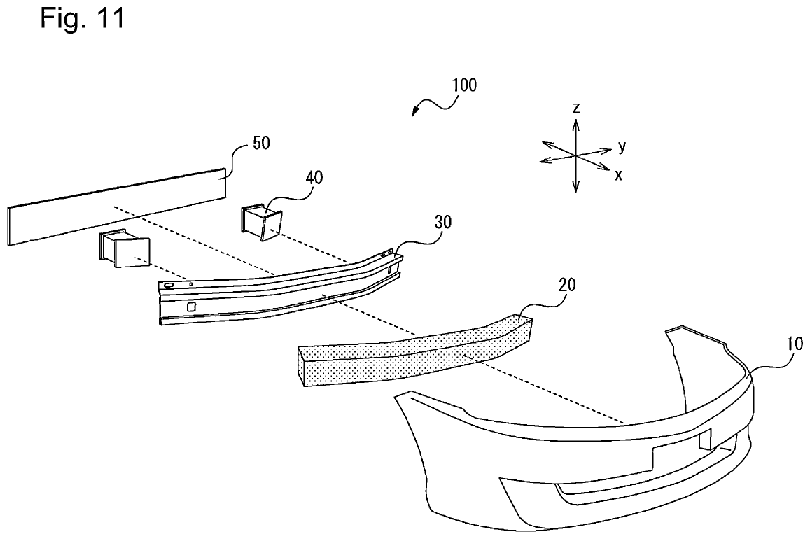

In the present disclosure, a “front direction of a vehicle” and a “rear direction of a vehicle” refer to an x direction and a −x direction in FIG. 11, an “upper direction of a vehicle” and a “lower direction of a vehicle” refer to a z direction and a −z direction in FIG. 11, and a “width direction of a vehicle” refers to ±y directions in FIG. 11. In the present disclosure, a “vehicle” refers to an entire automobile, and a “vehicle body” refers to a portion that is located inside the vehicle relative to a bumper structure and on which an occupant or luggage is placed. In the following description, unless otherwise specified, for example, in a case where an up-down direction, a front-rear direction, and a width direction are used, they mean the up-down direction of the vehicle, the front-rear direction of the vehicle, and the width direction of the vehicle, respectively.

In the present disclosure, joining means joining objects to each other, and adhesion and welding are subordinate concepts thereof. Adhesion means that two adherends (objects to be adhered) are brought into a joined state via an organic material (curable resin, thermoplastic resin, or the like) such as a tape or an adhesive. Welding means that a surface of a thermoplastic resin or the like as an adherend is melted by heat and brought into a joined state by entanglement and crystallization due to molecular diffusion by contact pressurization and cooling.

### Bumper Reinforcement

An automobile includes a bumper structure at each of front and rear portions of the vehicle. As illustrated in FIG. 11, a bumper structure 100 typically includes a bumper fascia 10, an energy absorber 20, a bumper reinforcement 30, a crash box 40, and a vehicle body fixing member 50 in this order from the front or rear portion of the vehicle. These members have different degrees of rigidity and have an ability to absorb an energy at the time of collision from the outside. To efficiently absorb an impact energy, it is ideal that the bumper structure is configured to be plastically deformed or broken in the order from a member positioned outside the vehicle when the bumper structure receives a collision energy from the outside.

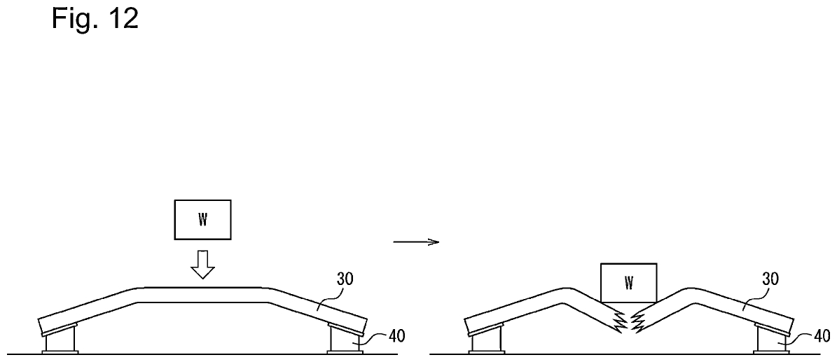

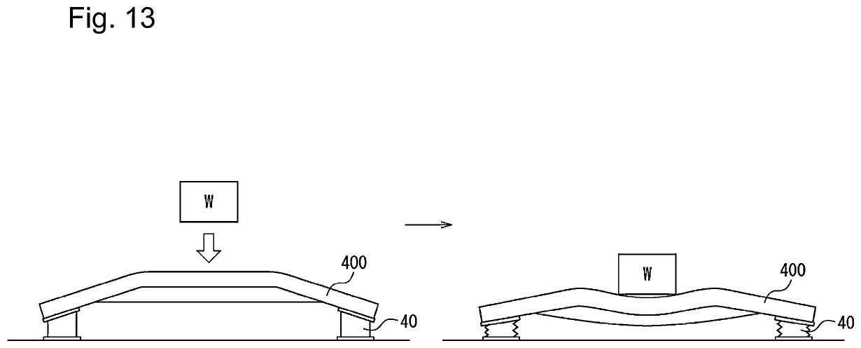

For example, as illustrated in FIG. 12, in a case where the bumper reinforcement 30 that is easily broken or excessively plastically deformed due to weight reduction is disposed in the bumper structure, when a heavy load W is applied, the crash box 40 is not easily crushed and thus it is impossible to efficiently absorb an impact energy. On the other hand, in the bumper reinforcement 400 of the present disclosure, the resin reinforcing portion having one or more reinforcing ribs that protrude toward the vehicle body and extend along the vehicle width direction is disposed closer to the vehicle body than the body constituting the bumper reinforcement 400 and joined to the body. As a result, as illustrated in FIG. 13, when the bumper reinforcement 400 of the present disclosure receives the heavy load W, the bumper reinforcement 400 is plastically deformed without causing a problem such as breakage while transmitting the impact energy to the crash box 40 to deform the crash box 40, and thus the bumper structure including the bumper reinforcement 400 can efficiently absorb the impact energy.

A mass per unit length (g/m) of the bumper reinforcement can be less than 2700 g/m, 2650 g/m or less, or 2600 g/m or less. The lower limit of the mass per unit length is not particularly limited, and can be, for example, 2000 g/m or more, 2200 g/m or more, 2400 g/m or more, or 2500 g/m or more. The mass per unit length is an index of the weight reduction of the bumper reinforcement. In a case where the bumper reinforcement is bent, for example, the unit length of the bumper reinforcement means a length along a direction in which the bumper reinforcement extends.

A residual strain amount of the bumper reinforcement can be less than 0.50%, 0.45% or less, or 0.40% or less, and can be 0.20% or more, 0.25% or more, or 0.30% or more under conditions of a temperature of 25° C., a load of 5 t, and a displacement speed of 1 mm/min. The residual strain amount is an index of whether or not the bumper reinforcement exhibits appropriate rigidity and plastic deformation.

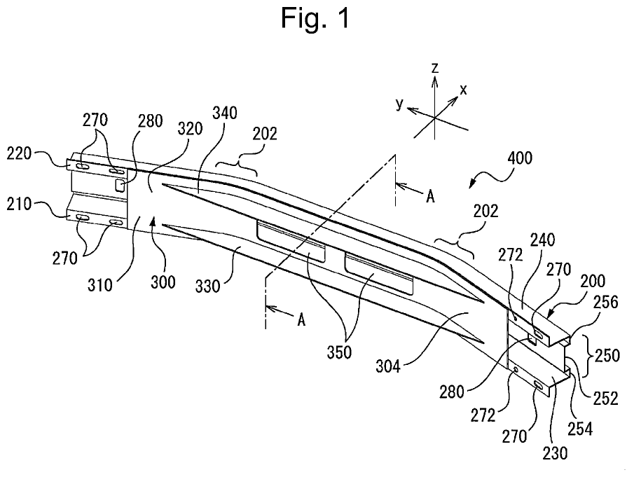

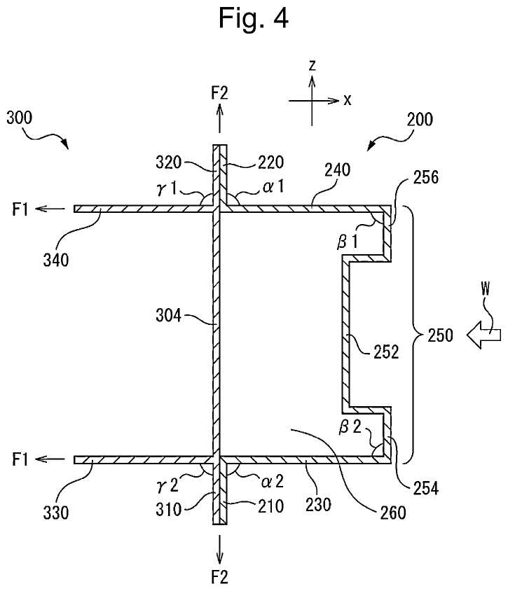

FIG. 1 is a schematic perspective view of a bumper reinforcement according to an embodiment, and FIG. 4 is a cross-sectional view taken along line A-A in FIG. 1. The bumper reinforcement 400 includes a body 200 extending along the vehicle width direction and a resin reinforcing portion 300 extending in the vehicle width direction and disposed closer to the vehicle body than the body 200. Hereinafter, the body 200 and the resin reinforcing portion 300 constituting the bumper reinforcement will be described in order. For ease of understanding, the bumper reinforcement described herein refers to a bumper reinforcement mounted on a bumper structure (front bumper) at a front portion of the vehicle, but the bumper reinforcement of the present disclosure can also be mounted on a bumper structure (rear bumper) at a rear portion of the vehicle. In a case where the bumper reinforcement of the present disclosure is employed in the rear bumper, a “front surface portion” in the following description can be read as a “rear surface portion”.

A length of the resin reinforcing portion 300 in the vehicle width direction can be 50% or more, 55% or more, 60% or more, 65% or more, 70% or more, 75% or more, or 85% or more, and 100% or less, 95% or less, 90% or less, 85% or less, 80% or less, or 75% or less of a length of the body 200 in the vehicle width direction.

### Body

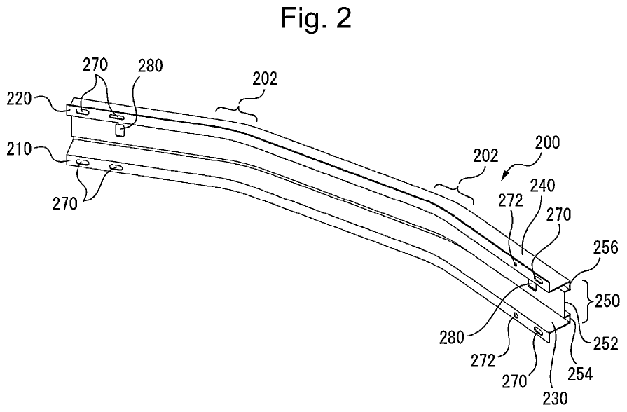

The body of the embodiment is illustrated in FIG. 2. The body 200 extends along the vehicle width direction and includes a lower first joining portion 210 and an upper first joining portion 220 on the vehicle body side. The body 200 is gently bent at a bent portion 202 by, for example, bending in accordance with the design of a bumper. As a result, left and right end portions of the body 200 are positioned further rearward in the front-rear direction of the vehicle than a central portion of the body 200. In a case of the rear bumper, the left and right end portions of the body 200 are positioned further forward in the front-rear direction of the vehicle than the central portion of the body 200.

On left and right end portions of the lower first joining portion 210 and the upper first joining portion 220, there are provided elongated holes 270 and positioning holes 272 for attaching the bumper reinforcement 400 to the crash box 40 with a fastener such as a bolt and a nut, or a screw. In addition to such holes, for example, a hole for weight reduction, a relief hole for relieving deformation stress caused by bending, and a hole for inserting a wrench tool for bolt fastening may be formed in the body.

The body 200 includes a lower portion 230, a front surface portion 250, and an upper portion 240 configured to connect the lower first joining portion 210 and the upper first joining portion 220. The front surface portion 250 includes a central recess 252, a lower surface 254, and an upper surface 256, which extend along the width direction of the vehicle. When the central recess 252 is provided, it is possible to increase the rigidity of the body 200 while reducing the weight of the body 200.

Openings 280 for attaching or positioning the energy absorber 20 such as a urethane foam or a polypropylene foam are provided at left and right end portions of the front surface portion 250.

The body 200 has a hollow structure from the viewpoint of weight reduction, and specifically has an open cross section. As illustrated in FIGS. 2 and 4, the cross-sectional shape of the body 200 is a so-called hat shape in which the lower first joining portion 210 and the upper joining portion 220 extend downward and upward from the lower portion 230 and the upper portion 240, respectively, and the side opposite to the front surface portion 250 is open. The body 200 illustrated in FIG. 4 can be referred to as a W-hat body because it includes the central recess 252 and thus the cross-sectional shape when rotated 90 degrees to the right is in the form of a W-hat.

The dimension, thickness, and shape of the body 200 can be appropriately set in accordance with the vehicle (for example, a passenger car, a truck, or the like) to which the bumper reinforcement is attached and required performance (for example, weight reduction, appropriate rigidity, and plastic deformability).

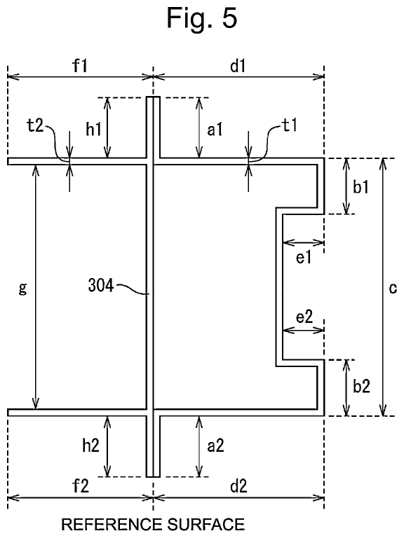

FIG. 5 is a cross-sectional view illustrating dimensions of the body 200 and the resin reinforcing portion 300. The following description using FIG. 5 is not limited to the embodiment in which the cross-sectional shape of the body is as illustrated in FIG. 5.

A width a1 of the upper first joining portion 220 and a width a2 of the lower first joining portion 210 can each independently be 10 mm or more, 15 mm or more, 20 mm or more, or 25 mm or more, and can each independently be 50 mm or less, 45 mm or less, 40 mm or less, or 35 mm or less. The width of the first joining portion can be appropriately set in accordance with a joining force required between the first joining portion and the second joining portion of the resin reinforcing portion to be joined, and the like.

A depth d1 of the upper portion 240 and a depth d2 of the lower portion 230 can each independently be 20 mm or more, 30 mm or more, 40 mm or more, or 50 mm or more, and can be 100 mm or less, 90 mm or less, 80 mm or less, or 70 mm or less. The depths d1 and d2 of the upper portion 240 and the lower portion 230 can be appropriately set in accordance with required rigidity and plastic deformability.

A height c of the front surface portion 250 can be 50 mm or more, 60 mm or more, 80 mm or more, or 100 mm or more, and can be 200 mm or less, 180 mm or less, 160 mm or less, or 150 mm or less. The height c of the front surface portion 250 can be appropriately set in accordance with required rigidity and plastic deformability.

In a case where the body 200 is a W-hat body, a height b1 of the upper surface 256 and a height b2 of the lower surface 254 can each independently be 5 mm or more, 10 mm or more, 13 mm or more, or 15 mm or more, and can be 40 mm or less, 35 mm or less, 30 mm or less, or 25 mm or less. A depth e1 from the upper surface 256 to the central recess 252 and a depth e2 from the lower surface 254 to the central recess 252 can each independently be 5 mm or more, 8 mm or more, 10 mm or more, or 13 mm or more, and can be 35 mm or less, 30 mm or less, 25 mm or less, or 20 mm or less. The b1, b2, e1, and e2 can be appropriately set in accordance with required rigidity and plastic deformability.

A thickness t1 of the body 200 can be 1.0 mm or more, 1.5 mm or more, or 2.0 mm or more, and can be 5.0 mm or less, 4.5 mm or less, or 4.0 mm or less. A thickness of each portion (for example, the first joining portion) constituting the body can be appropriately set in accordance with required performance such as weight reduction, appropriate rigidity, and plastic deformability. The thickness of the body 200 may be the same at each portion or may be different at each portion.

An angle α1 formed by the upper portion 240 and the upper first joining portion 220 in the body 200 illustrated in FIG. 4 can be 75 degrees or more, 80 degrees or more, or 85 degrees or more, and can be 105 degrees or less, 100 degrees or less, or 95 degrees or less. The angle α1 is preferably 90 degrees. This angle can be similarly applied to an angle α2 formed by the lower portion 230 and the lower first joining portion 210.

An angle β1 formed by the upper surface 256 and the upper portion 240 of the front surface portion 250 can be 75 degrees or more, 80 degrees or more, or 85 degrees or more, and can be 105 degrees or less, 100 degrees or less, or 95 degrees or less. The angle β1 is preferably 90 degrees. This angle can also be applied to an angle β2 formed by the lower surface 254 of the front surface portion 250 and the lower portion 230.

Examples of the material of the body include a metal material and a metal alloy material. Among them, aluminum and an aluminum alloy are preferable, and an aluminum alloy is more preferable. These materials may be used alone or in combination of two or more.

As the aluminum alloy, an aluminum alloy having a tensile strength of 350 MPa or more, 400 MPa or more, or 450 MPa or more is preferable from the viewpoint of weight reduction, appropriate rigidity, plastic deformability, and the like. The upper limit of the tensile strength of such an alloy is not particularly limited and can be, for example, 600 MPa or less, 550 MPa or less, or 500 MPa or less. Herein, the tensile strength is a value measured using a universal tester (AG-100KNX, available from Shimadzu Corporation) in accordance with JIS Z 2241.

Examples of such an aluminum alloy include alloys having an aluminum content of 50 mass % or more, and specific examples thereof include A7000-series alloys (for example, A7003, A7075, and A7N01), A6000-series alloys (for example, A6061, A6082, and A6110), A5000-series alloys, and A3000-series alloys.

The body may be an extruded shape, a die cast material, a cast material, a forged material, or the like formed using a metal material or a metal alloy material. Among them, an extruded shape is preferable from the viewpoint of productivity and the like.

The extruded shape of the body can be produced, for example, as follows. A step of continuously casting a cast rod by supplying a molten metal of a metal material or a metal alloy material having predetermined properties to a continuous casting apparatus, a step of homogenizing the cast rod, a step of cutting the cast rod to a predetermined length to obtain a billet as a material for extrusion, a step of chamfering the outside edge of the billet, and a step of water-cooling-quenching the billet immediately after hot extrusion to form an extruded shape having a predetermined cross-sectional shape are performed in the mentioned order. Next, the extruded shape is cut to a predetermined length, predetermined processing such as chamfering and deburring is performed on both cut end surfaces, and a bent portion is formed by bending, whereby the extruded shape can be formed. The extruded shape can be subjected to a heat treatment step such as an artificial aging treatment either before or after cutting of the extruded shape or before or after bending of the extruded shape. For example, in a case where the extruded shape is formed using an A6000-series alloy and/or an A7000-series alloy, it is preferable to perform such a heat treatment step.

### Resin Reinforcing Portion

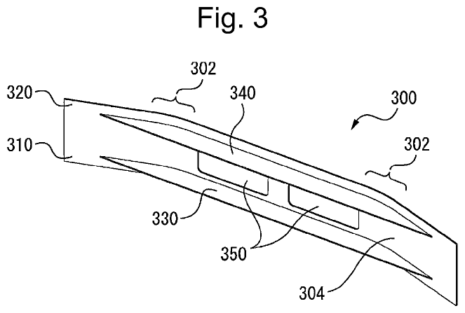

FIG. 3 illustrates a resin reinforcing portion of the embodiment. The resin reinforcing portion 300 includes at least one second joining portion extending along the vehicle width direction. In a case of FIG. 3, the resin reinforcing portion 300 includes a lower second joining portion 310 and an upper second joining portion 320 as the second joining portions. In a case where the resin reinforcing portion 300 includes two second joining portions, i.e., the lower second joining portion 310 and the upper second joining portion 320, the resin reinforcing portion 300 preferably includes a resin main body 304.

The resin main body 304 has a plate shape with the vehicle width direction as a longitudinal direction, the vehicle up-down direction as a lateral direction, and the vehicle front-rear direction as a thickness direction, and includes a bent portion 302 at a position corresponding to the bent portion 202 of the body 200. The resin main body 304 integrally includes the lower second joining portion 310 and the upper second joining portion 320 on the lower side and the upper side of the main body surface, respectively.

The lower second joining portion 310 is a strip-shaped region that is disposed on the lower side of the resin main body 304, extends from one end to the other end in the vehicle width direction, and has a predetermined width. The upper second joining portion 320 is a strip-shaped region that is disposed on the upper side of the resin main body 304, extends from one end to the other end in the vehicle width direction, and has a predetermined width. Widths of the lower second joining portion 310 and the upper second joining portion 320 are selected in accordance with the length of the first joining portion in the vehicle up-down direction. In this way, the lower second joining portion 310 and the upper second joining portion 320 extend over the entire region of the resin main body 304 in the longitudinal direction. The lower second joining portion 310 and the upper second joining portion 320 are integrated via the resin main body 304. The lower second joining portion 310 and the upper second joining portion 320 are joined to the lower first joining portion 210 and the upper first joining portion 220, respectively, in a state where the surfaces of the lower second joining portion 310 and the upper second joining portion 320 on the body side are in contact with the lower first joining portion 210 and the upper first joining portion 220, respectively.

As illustrated in FIGS. 1 and 4, the lower second joining portion 310 and the upper second joining portion 320 of the resin reinforcing portion 300 are joined to the lower first joining portion 210 and the upper first joining portion 220 of the body, respectively. The lower second joining portion 310 and the upper second joining portion 320 are joined to the lower first joining portion 210 and the upper first joining portion 220 at joined surfaces intersecting the front-rear direction of the vehicle. The body 200 has an open cross section, and the lower first joining portion 210 and the upper first joining portion 220 of the body 200 are joined to the lower second joining portion 310 and the upper second joining portion 320 of the resin reinforcing portion 300, respectively, to form a hollow portion 260 inside the body 200.

The resin reinforcing portion 300 includes a lower reinforcing rib 330 and an upper reinforcing rib 340 that protrude toward the vehicle body and extend along the vehicle width direction. As illustrated in FIG. 4, the lower reinforcing rib 330 and the upper reinforcing rib 340 are disposed corresponding to the lower first joining portion 210 and the upper first joining portion 220 of the body 200, respectively. As a result, appropriate rigidity and plastic deformability can be imparted to the bumper reinforcement by using the resin reinforcing portion 300 having a lighter weight.

Herein, “disposed corresponding to the first joining portion” means that one reinforcing rib of interest is disposed at a position where it can be specified through mainly which first joining portion the reinforcing rib brings about an advantageous effect on the rigidity and the plastic deformability of the bumper reinforcement. The arrangement relationship of the reinforcing ribs in the resin reinforcing portion will be described with reference to, for example, the upper first joining portion 220 and the upper reinforcing rib 340 in FIG. 4. From the viewpoint of appropriate rigidity and plastic deformability, a position of the upper reinforcing rib 340 in the z direction is preferably, from within a range of the upper first joining portion 220, in a range within 10 mm, within 5 mm, or within 3 mm from the upper first joining portion 220 in a region of a hollow portion 260 lower than the upper first joining portion 220. A more preferable position of the upper reinforcing rib 340 in the z direction is a range of within 10 mm, within 5 mm, or within 3 mm above the position of the upper portion 240 in the z direction, and as illustrated in FIG. 4, it is particularly preferable that the reinforcing rib be disposed to coincide with the position of the upper portion 240 in the z direction. This arrangement relationship can be similarly applied to the lower reinforcing rib 330.

The resin reinforcing portion only needs to include one or more reinforcing ribs. In a case where there are a plurality of first joining portions, it is preferable that a plurality of reinforcing ribs be disposed to respectively correspond to the first joining portions. A plurality of reinforcing ribs may be disposed for one first joining portion. In a case where a plurality of reinforcing ribs are disposed for one first joining portion, it is preferable to arrange the reinforcing ribs symmetrically from the viewpoint of receiving impact in a balanced manner. The upper limit of the number of reinforcing ribs to be disposed is not particularly limited, and can be six or less or four or less. However, from the viewpoint of weight reduction, the number of reinforcing ribs is preferably two or less.

The resin reinforcing portion may include one or more additional reinforcing ribs extending in the up-down direction. The upper limit of the number of additional reinforcing ribs (second reinforcing ribs) to be disposed is not particularly limited and can be six or less or four or less. In consideration of weight reduction, the number of additional reinforcing ribs is preferably two or less, and it is more preferable that no additional reinforcing rib be disposed.

The dimension, thickness, and shape of the resin reinforcing portion 300 can be appropriately set in accordance with a vehicle (for example, a passenger car, a truck, or the like) to which the bumper reinforcement is attached and required performance (for example, weight reduction, appropriate rigidity, and plastic deformability).

A width h1 of the upper second joining portion 320 and a width h2 of the lower second joining portion 310 can each independently be 10 mm or more, 15 mm or more, 20 mm or more, or 25 mm or more, and can be 50 mm or less, 45 mm or less, 40 mm or less, or 35 mm or less. The width of the second joining portion can be appropriately set in accordance with a joining force required between the second joining portion and the first joining portion of the body to be joined, and the like.

A protrusion amount f1 of the upper reinforcing rib 340 and a protrusion amount f2 of the lower reinforcing rib 330 can each independently be 30 mm or more, 35 mm or more, 40 mm or more, or 45 mm or more, and can be 100 mm or less, 90 mm or less, 80 mm or less, 70 mm or less, or 60 mm or less. The protrusion amount of the reinforcing rib can be appropriately set in accordance with the required rigidity and plastic deformability. In FIG. 3, the resin reinforcing portion 300 is bent at the bent portion 302, and thus the protrusion amounts of the lower reinforcing rib 330 and the upper reinforcing rib 340 gradually decrease outside the bent portion 302. In this case, the protrusion amounts f1 and f2 mean maximum protrusion amounts. The protrusion amount of the reinforcing rib may or may not change in the vehicle width direction. As illustrated in FIG. 3, it is preferable that a line connecting tips of the reinforcing ribs 330 and 340 on the vehicle body side be parallel to the vehicle width direction.

A distance g between the upper reinforcing rib 340 and the lower reinforcing rib 330 can be 50 mm or more, 60 mm or more, 80 mm or more, or 100 mm or more, and can be 200 mm or less, 180 mm or less, 160 mm or less, or 150 mm or less. In a case where two or more reinforcing ribs are provided, a distance between the reinforcing ribs can be appropriately set in accordance with required rigidity and plastic deformability.

A length of the reinforcing rib in the vehicle width direction can be 50% or more, 55% or more, 60% or more, 65% or more, 70% or more, 75% or more, or 85% or more, and 100% or less, 90% or less, 85% or less, 80% or less, or 75% or less of the length of the body in the vehicle width direction.

A thickness t2 of the resin reinforcing portion can be 1.0 mm or more, 1.5 mm or more, or 2.0 mm or more, and can be 5.0 mm or less, 4.5 mm or less, or 4.0 mm or less. Thicknesses of respective portions (for example, the reinforcing rib and the second joining portion) constituting the resin reinforcing portion can be appropriately set in accordance with required performance such as weight reduction, appropriate rigidity, and plastic deformability. The thickness of the resin reinforcing portion 300 may be the same at each portion, or may be different at each portion.

An angle γ1 formed by the upper second joining portion 320 and the upper reinforcing rib 340 in the resin reinforcing portion 300 illustrated in FIG. 4 can be 75 degrees or more, 80 degrees or more, or 85 degrees or more, and can be 105 degrees or less, 100 degrees or less, or 95 degrees or less. The angle γ1 is preferably 90 degrees. This angle can also be applied to an angle γ2 formed by the lower second joining portion 310 and the lower reinforcing rib 330.

The resin reinforcing portion 300 illustrated in FIG. 3 includes two lightening holes 350 in the vicinity of the center. When the lightening holes are provided, it is possible to further reduce the weight of the resin reinforcing portion. One or more lightening holes only need to be provided, and the number, size, and shape of the lightening holes can be appropriately set in accordance with required performance (for example, weight reduction, appropriate rigidity, and plastic deformability).

The material of the resin reinforcing portion is not particularly limited as long as it is a resin material. Examples of the material of the resin reinforcing portion include a thermoplastic resin and a thermosetting resin. Specifically, the resin reinforcing portion preferably contains at least one selected from the group consisting of a thermoplastic resin, a thermosetting resin, and a fiber-reinforced plastic (FRP), and the material is more preferably a thermoplastic resin from the viewpoints of an adhesive force, cost, and ease of molding.

For example, the thermoplastic resin is preferably one or more selected from the group consisting of polyolefins and acid-modified products thereof, polystyrene, polymethyl methacrylate, AS resins, ABS resins, thermoplastic aromatic polyesters such as polyethylene terephthalate and polybutylene terephthalate, polycarbonate, polyimide, polyamide, polyamideimide, polyetherimide, polyethersulfone, polyphenylene ether and modified products thereof, polyphenylene sulfide, polyoxymethylene, polyarylate, polyetherketone, polyetheretherketone, polyetherketoneketone, and thermoplastic epoxy resins. As the thermosetting resin, for example, one or more selected from the group consisting of an epoxy resin, a vinyl ester resin, a phenol resin, and a urethane resin can be used. The thermoplastic resin and the thermosetting resin may be used alone or in combination of two or more thereof.

The material of the resin reinforcing portion may be a resin produced by blending a reinforcing fiber (for example, a carbon fiber, a glass fiber, or a cellulose nanofiber) to the above-described resin material. Examples of such a material include a carbon fiber-reinforced resin (CFRP) and a glass fiber-reinforced resin (GFRP).

As the material of the resin reinforcing portion, among the above-described materials, it is preferable to use resins having an elastic modulus of 5 GPa or more, 7 GPa or more, or 10 GPa or more at 80° C. from the viewpoint of weight reduction, appropriate rigidity, and plastic deformability. The upper limit of the elastic modulus is not particularly limited, and can be, for example, 70 GPa or less, 60 GPa or less, or 50 GPa or less. Herein, the elastic modulus is a value measured using a universal tester (AG-100KNX, available from Shimadzu Corporation) in accordance with JIS K 7161.

The resin reinforcing portion can be molded using a known molding method, for example, an injection molding method (including an insert molding method), a transfer molding method, a press molding method, a filament winding molding method, or a hand lay-up molding method.

### Method for Producing Bumper Reinforcement 30 (Joined Body)

A method for producing a bumper reinforcement according to the present invention includes a pre-joining process of forming a laminate in which a metal member (hereinafter also referred to as “base material A”), a solid joining agent containing, as a main component, an amorphous thermoplastic resin which is at least one of a thermoplastic epoxy resin or a phenoxy resin, and a resin member to be joined to the metal member (hereinafter also referred to as “base material B”) are arranged in this order, and a joining process of joining the metal member and the resin member by heating and pressurizing the laminate to melt the solid joining agent. In the pre-joining process, joining between the base material A and the solid joining agent and joining between the base material B and the solid joining agent are not performed, but joining is performed in the next joining process. The solid joining agent may have tackiness, and in this case, the solid joining agent is temporarily fixed to the base material in the pre-joining process.

The metal member (base material A) is the body extending along the vehicle width direction and including at least one first joining portion on the vehicle body side. The resin member (base material B) is the resin reinforcing portion extending along the vehicle width direction and including at least one second joining portion. The first joining portion of the body and the second joining portion of the resin member are joined to each other via the solid joining agent.

### Pre-Joining Process

In the pre-joining process, a laminate is formed in which the base material A, the solid joining agent containing, as a main component, an amorphous thermoplastic resin which is at least one of a thermoplastic epoxy resin or a phenoxy resin, and the base material B are arranged in this order. In the laminate, neither the base material A and the solid joining agent nor the solid joining agent and the base material B are joined to each other, and independent members are superposed on each other.

“Solid” of the solid joining agent means that it is solid at room temperature, i.e., it does not have fluidity at 23° C. without pressurization. It is desirable that the solid joining agent be capable of retaining its outer shape without deformation for 30 days or longer under a non-pressurized state at 23° C., and further have a property of not deteriorating.

The “main component” means a component having the highest content among the resin components in the solid joining agent and having a content of 50 mass % or more in the resin components in the solid joining agent. The solid joining agent contains the resin component in an amount of preferably 50 mass % or more, more preferably 70 mass % or more, still more preferably 80 mass % or more, and particularly preferably 90% mass % or more.

### Solid Joining Agent

The solid joining agent contains, as a main component, an amorphous thermoplastic resin which is at least one of a thermoplastic epoxy resin or a phenoxy resin, having an epoxy equivalent of 1600 or more, and having a heat of fusion of 15 J/g or less.

The amorphous resin in the present disclosure is a resin that has a melting point (Tm) but does not have a clear endothermic peak (melting point) associated with melting or has a very small endothermic peak in measurement using a differential scanning calorimeter (DSC). The heat of fusion is calculated from an area of the endothermic peak of DSC and a mass of the thermoplastic resin component. In a case where an inorganic filler or the like is contained in the solid joining agent, the heat of fusion is calculated from the mass of the resin component excluding the inorganic filler. Specifically, the amorphous thermoplastic resin in the present disclosure refers to the following. 2 to 10 mg of a sample is weighed, placed in an aluminum pan, and heated from 23° C. to 200° C. or higher at 10° C./min using a DSC (DSC8231 available from Rigaku Corporation) to obtain a DSC curve. Then, when the heat of fusion is calculated from the area of an endothermic peak at the time of melting as determined from the DSC curve and the weighed value, those having a heat of fusion of 15 J/g or less are regarded as amorphous thermoplastic resins.

From the viewpoint of sufficiently imparting the properties of the amorphous thermoplastic resin to the solid joining agent, the content of the amorphous thermoplastic resin is preferably 60 mass % or more, more preferably 70 mass % or more, still more preferably 80 mass % or more, and most preferably 90 mass % or more of the resin components in the solid joining agent.

The heat of fusion is 15 J/g or less, preferably 11 J/g or less, more preferably 7 J/g or less, even more preferably 4 J/g or less, and it is most preferable that the fusion peak be the detection limit or less.

The epoxy equivalent is 1600 or more, preferably 2000 or more, more preferably 5000 or more, even more preferably 9000 or more, and it is most preferable that the epoxy equivalent be the detection limit or more and the epoxy group be not substantially detected.

When the solid joining agent containing, as a main component, an amorphous thermoplastic resin having an epoxy equivalent of 1600 or more and a heat of fusion of 15 J/g or less is used, a rapid decrease in viscosity as found in a hot melt adhesive in the related art does not occur during heating, and a low viscosity (0.001 to 100 Pa-s) state is not achieved even in a high temperature region exceeding 200° C. Accordingly, the solid joining agent does not flow out from the laminate even in a molten state, and the thickness of the adhesive layer can be stably secured, and a high adhesive force can be stably obtained. The epoxy equivalent (the mass of the resin containing 1 mol of an epoxy group) in the present disclosure is a value of the epoxy equivalent of the thermoplastic epoxy resin or the phenoxy resin component contained in the solid joining agent before joining, and is a value (in “g/eq.”) measured by the method defined in JIS K 7236:2001. Specifically, the epoxy equivalent of a resin is measured using a potentiometric titrator, using cyclohexanone as a solvent, adding a solution of tetraethylammonium bromide in acetic acid to the resin, and using 0.1 mol/L perchloric acid-acetic acid solution. With regard to a solvent-diluted product (resin varnish), the epoxy equivalent is calculated as a numerical value in terms of solid content based on a volatile component. The epoxy equivalent of a mixture of two or more resins can also be calculated from the content and the epoxy equivalent of each resin.

A melting point of the amorphous thermoplastic resin that is the main component of the solid joining agent is preferably from 50° C. to 400° C., more preferably from 60° C. to 350° C., and even more preferably from 70° C. to 300° C. When the melting point is in a range of 50 to 400° C., the solid joining agent is efficiently deformed and melted by heating and effectively wet-spreads on a bonding surface, and thus a high adhesive force can be achieved. In the present disclosure, the melting point of the amorphous thermoplastic resin means a temperature at which the amorphous thermoplastic resin is substantially softened from a solid state to become thermoplastic and can be melted and bonded.

In a joined body containing a thermosetting adhesive in the related art, it is difficult to disassemble the joined body, and it is difficult to separate different materials constituting the joined body for recycling (i.e., poor in recyclability). In addition, in a case of using a thermosetting adhesive, it is difficult to re-attach (i.e., poor in repairability) when a joined portion is displaced or the like in a production process of a joined body or when an adherend has a defect and needs to be replaced, resulting in lack of convenience. On the other hand, the solid joining agent can be softened and melted by heat and two adherends can be easily separated from each other, thereby providing excellent recyclability. In addition, the solid joining agent is thermoplastic, and thus, softening, melting, and curing (solidification) can be reversibly repeated, and the repairability is also excellent.

### Thermoplastic Epoxy Resin

The thermoplastic epoxy resin is preferably a polymer of (a) a bifunctional epoxy resin monomer or oligomer and (b) a bifunctional compound having two identical or different functional groups selected from the group consisting of a phenolic hydroxyl group, a carboxyl group, a mercapto group, an isocyanate group, and a cyanate ester group. When such a compound is used, a polymerization reaction for forming a linear polymer preferentially proceeds, thereby allowing formation of a thermoplastic epoxy resin having desired properties.

The (a) bifunctional epoxy resin monomer or oligomer refers to an epoxy resin monomer or oligomer having two epoxy groups in the molecule. Examples of the (a) bifunctional epoxy resin monomer or oligomer include a bisphenol A-type epoxy resin, a bisphenol F-type epoxy resin, a bifunctional phenol novolak-type epoxy resin, a bisphenol AD-type epoxy resin, a biphenyl-type epoxy resin, a bifunctional naphthalene-type epoxy resin, a bifunctional alicyclic epoxy resin, a bifunctional glycidyl ester-type epoxy resin (e.g., diglycidyl phthalate, diglycidyl tetrahydrophthalate, dimer acid diglycidyl ester), a bifunctional glycidylamine-type epoxy resin (e.g., diglycidyl aniline, diglycidyl toluidine), a bifunctional heterocyclic epoxy resin, a bifunctional diarylsulfone-type epoxy resin, a hydroquinone-type epoxy resin (e.g., hydroquinone diglycidyl ether, 2,5-di-tert-butylhydroquinone diglycidyl ether, resorcinol diglycidyl ether), a bifunctional alkyleneglycidyl ether-based compound (e.g., butanediol diglycidyl ether, butenediol diglycidyl ether, butynediol diglycidyl ether), a bifunctional glycidyl group-containing hydantoin compound (e.g., 1,3-diglycidyl-5,5-dialkylhydantoin, 1-glycidyl-3-(glycidoxyalkyl)-5,5-dialkylhydantoin), a bifunctional glycidyl group-containing siloxane (e.g., 1,3-bis(3-glycidoxypropyl)-1,1,3,3-tetramethyldisiloxane, α,β-bis(3-glycidoxypropyl)polydimethylsiloxane), and modified products thereof. Among these, a bisphenol A-type epoxy resin, a bisphenol F-type epoxy resin, a bisphenol S-type epoxy resin, and a biphenyl-type epoxy resin are preferable in terms of reactivity and workability.

Examples of the (b) bifunctional compound having a phenolic hydroxyl group include mononuclear aromatic dihydroxy compounds having one benzene ring such as catechol, resorcinol, and hydroquinone; bisphenol compounds such as bis(4-hydroxyphenyl)propane (bisphenol A), bis(4-hydroxyphenyl)methane (bisphenol F), and bis(4-hydroxyphenyl)ethane (bisphenol AD); compounds having a condensed ring such as dihydroxynaphthalene; bifunctional phenol compounds having an allyl group such as diallylresorcinol, diallylbisphenol A and triallyldihydroxybiphenyl; and dibutylbisphenol A.

Examples of the (b) bifunctional compound having a carboxyl group include adipic acid, succinic acid, malonic acid, cyclohexanedicarboxylic acid, phthalic acid, isophthalic acid, and terephthalic acid.

Examples of the (b) bifunctional compound having a mercapto group include ethylene glycol bisthioglycolate and ethylene glycol bisthiopropionate.

Examples of the (b) bifunctional compound having an isocyanate group include diphenylmethane diisocyanate (MDI), isophorone diisocyanate (IPDI), hexamethylene diisocyanate (HMDI), and tolylene diisocyanate (TDI).

Examples of the (b) bifunctional compound having a cyanate ester group include 2,2-bis(4-cyanatophenyl)propane, 1,1-bis(4-cyanatophenyl)ethane, and bis(4-cyanatophenyl)methane.

Among the (b) described above, a bifunctional compound having a phenolic hydroxyl group is preferable because it can form a thermoplastic polymer having suitable properties, a bifunctional compound having two phenolic hydroxyl groups and having a bisphenol structure or a biphenyl structure is preferable from the viewpoint of heat resistance and adhesiveness, and bisphenol A, bisphenol F, and bisphenol S are preferable from the viewpoint of heat resistance and cost.

In a case where the (a) is a bisphenol A-type epoxy resin, a bisphenol F-type epoxy resin, a bisphenol S-type epoxy resin, or a biphenyl-type epoxy resin, and the (b) is bisphenol A, bisphenol F, or bisphenol S, the polymer produced by polymerization of the (a) and (b) has a structure in which a main chain has a paraphenylene structure and an ether bond as a main skeleton, the paraphenylene structure and the ether bond being linked by an alkylene group, and a hydroxyl group generated by polyaddition is arranged in a side chain. A linear structure derived from the main skeleton having the paraphenylene structure and the ether bond can enhance the mechanical strength of the polymer after polymerization, and the hydroxyl group arranged in the side chain can improve the adhesion to the base material. As a result, high adhesive strength at the same level as that of a thermosetting resin can be realized while maintaining workability. Furthermore, by softening and melting with heat, recycling and repairing become possible, and recyclability and repairability which are problems in thermosetting resin can be improved.

### Phenoxy Resin

The phenoxy resin is a polyhydroxy polyether synthesized from a bisphenol compound and epichlorohydrin, and has thermoplasticity. As a method for producing the phenoxy resin, there are known a method of directly reacting a dihydric phenol compound with epichlorohydrin and a method of subjecting a diglycidyl ether of a dihydric phenol compound and a dihydric phenol compound to an addition polymerization reaction, and the phenoxy resin may be obtained by any of these methods. In the case of a direct reaction between a dihydric phenol compound and epichlorohydrin, examples of the dihydric phenol compound include phenol compounds such as bisphenol A, bisphenol F, bisphenol S, biphenol, biphenylene diol, and fluorene diphenyl. Among these, bisphenol A, bisphenol F, and bisphenol S are preferable from the viewpoints of cost, adhesiveness, viscosity, and heat resistance. In addition to the dihydric phenol compound, an aliphatic glycol such as ethylene glycol, propylene glycol, or diethylene glycol may be included in the direct reaction. These may be used alone, or in combination of two or more thereof. The phenoxy resin has a chemical structure similar to that of an epoxy resin, and has a structure in which a main chain has a paraphenylene structure and an ether bond as a main skeleton, the paraphenylene structure and the ether bond being linked, and a hydroxyl group is arranged in a side chain.

### Thermoplastic Epoxy Resin and Phenoxy Resin

Weight average molecular weights of the thermoplastic epoxy resin and the phenoxy resin are each preferably 10000 to 500000, more preferably 18000 to 300000, and still more preferably 20000 to 200000 as a value measured by gel permeation chromatography (GPC) and calibrated with polystyrene. The weight average molecular weight is a value calibrated with standard polystyrene calculated from an elution peak position detected by GPC. When the weight average molecular weight is in the above range, thermoplasticity and heat resistance are well balanced, and thus, it is possible to efficiently form a joined body by melting and it is also possible to enhance heat resistance of the joined body. When the weight average molecular weight is 10000 or more, heat resistance is excellent, and when the weight average molecular weight is 500000 or less, viscosity at the time of melting is decreased and adhesiveness is increased.

### Method for Producing Solid Joining Agent

A method for producing the solid joining agent is not particularly limited. For example, the solid joining agent can be produced by heating and polymerizing a monomer or an oligomer of a bifunctional epoxy compound. A solvent may be added to reduce viscosity during polymerization to facilitate stirring. In a case where a solvent is added, it is necessary to remove the solvent, and the solid joining agent may be produced by performing drying and/or polymerization on a release film or the like.

As needed, another additive may be blended to the solid joining agent as long as the effects of the present invention are not impaired. A blending amount of the additive with respect to the total amount of the amorphous thermoplastic resin is preferably 50 vol. % or less, more preferably 30 vol. % or less, still more preferably 20 vol. % or less, and most preferably 10 vol. % or less. In the present disclosure, the vol. % of the additive represents a volume ratio of the additive contained before the polymerization of the monomer or oligomer of the bifunctional epoxy compound based on the volume of the total amount of the amorphous thermoplastic resin, and the volume of the additive can be determined by dividing the mass of the contained additive by the true specific gravity of the additive.

Examples of the additive include a viscosity modifier, an inorganic filler, an organic filler (resin powder), an antifoaming agent, a coupling agent such as a silane coupling agent, and a pigment. These additives may be used alone, or in combination of two or more. Examples of the viscosity modifier include a reactive diluent. Examples of the inorganic filler include spherical fused silica, metal powders of metals such as iron, silica sand, talc, calcium carbonate, mica, acid clay, diatomaceous earth, kaolin, quartz, titanium oxide, silica, phenol resin microballoon, and glass balloon.

The solid joining agent thus obtained has a low content of unreacted monomers or terminal epoxy groups or substantially no unreacted monomer or terminal epoxy group. Thus, the solid joining agent is excellent in storage stability and can be stored for a long period of time at room temperature.

The form of the solid joining agent is not particularly limited, and preferably has a shape selected from the group consisting of a film, a rod, a pellet, and a powder. In particular, at least one side of the outer shape of the solid joining agent is preferably 5 mm or less, more preferably 3 mm or less, further preferably 1 mm or less, still further preferably 0.5 mm or less, and most preferably 0.3 mm or less. When the size of the solid joining agent is within the above range, the solid joining agent can efficiently spread over a bonding surface when sandwiched between the base material A and the base material B and heated and pressurized, and a high adhesive force can be obtained.

The solid joining agent may have tackiness within a range that does not impair the adhesive force and the heat resistance. In this case, the solid joining agent can be temporarily fixed to the base materials in laminate preparation.

### Joining Process

In the joining process, the laminate is heated and pressurized to melt the solid joining agent, and then the temperature is lowered to solidify the solid joining agent, thereby joining the base material A and the base material B.

The temperature in the heating and pressurization is preferably from 100° C. to 400° C., more preferably from 120° C. to 350° C., and even more preferably from 150° C. to 300° C. When heating is performed at 100 to 400° C., the solid joining agent is efficiently deformed and melted to effectively wet-spread on the bonding surface, and thus a high adhesive force can be obtained.

The pressure in the heating and pressurization is preferably from 0.01 to 20 MPa, more preferably from 0.1 to 10 MPa, and still more preferably from 0.2 to 5 MPa. When the pressure is in such a range, the solid joining agent is efficiently deformed and effectively wet-spreads on the bonding surface, and thus a high adhesive force can be obtained. In a case where at least one of the base material A or the base material B contains a thermoplastic resin, the solid joining agent and the base material can be made compatible with each other by pressurization at 0.01 to 20 MPa to obtain a strong adhesive force.

The thermoplastic epoxy resin and the phenoxy resin, which are the main components of the solid joining agent, have a low cohesive force in the resin and have a hydroxyl group, and thus have strong interaction with the base material, and different materials can be joined with an adhesive force higher than that of a crystalline hot melt adhesive in the related art.

The joining between the base material A and the base material B utilizes a phase change (solid-liquid-solid) of the solid joining agent and does not involve a chemical reaction, and thus the joining can be completed in a shorter time than that of a thermosetting epoxy resin in the related art.

### Bumper Reinforcement 30 (Joined Body)

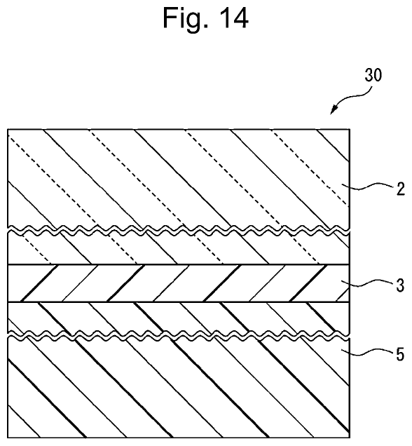

FIG. 14 is a schematic cross-sectional view illustrating a state in which the metal member 2 and the resin member 5 are joined to each other via the solid joining agent, and illustrates, for example, a joining portion between the lower first joining portion 210 (corresponding to the metal member 2) of the body 200 and the lower second joining portion 310 (corresponding to the resin member 5) of the resin reinforcing portion 300, or a joining portion between the upper first joining portion 220 (corresponding to the metal member 2) of the body 200 and the upper second joining portion 320 (corresponding to the resin member 5) of the resin reinforcing portion 300 illustrated in FIGS. 1 and 4.

In the joined body illustrated in FIG. 14, the metal member 2 and the resin member 5 are integrally joined to each other via the adhesive layer 3 formed by melting and then solidifying the solid joining agent containing an amorphous thermoplastic resin which is at least one of the thermoplastic epoxy resin or the phenoxy resin as a main component. Although the metal member 2 and the resin member 5 are different materials, the joined body exhibits excellent joining strength. The joining strength is affected by many factors such as the thickness of the adhesive layer, the molecular weight and chemical structure of the polymer constituting the adhesive, mechanical properties, and viscoelastic properties, in addition to the strength of interfacial interaction acting between the adhesive layer and the base material. Accordingly, although the details of the mechanism by which the joined body of the present disclosure exhibits excellent joining strength are not clear, it is presumed that the main factors are the low cohesive force of the amorphous thermoplastic resin constituting the adhesive layer 3 and the presence of hydroxyl groups in the resin to form chemical bonds or intermolecular forces, such as hydrogen bonds and van der Waals forces, at the interface between the adhesive layer and the metal member 2 and at the interface between the adhesive layer and the resin member 5. However, in the joined body, the state or property of the interface of the joined body is caused by an extremely thin chemical structure having a thickness of a nanometer level or less, and thus it is difficult to analyze the state or property. It is impossible or impractical in the current technology to distinguishably express the joined body and a joined body not containing the solid joining agent of the present disclosure by identifying the state or property of the interface of the joined body of the present disclosure.

The bumper reinforcement of the present disclosure in which the adhesive layer contains an amorphous thermoplastic resin is excellent in recyclability and repairability, and can be easily disassembled into the metal member 2 and the resin member 5, i.e., the body 200 and the resin reinforcing portion 300 by heating the joined body.

A high adhesive force may be obtained by subjecting the metal member 2, the resin member 5, or both to an appropriate pretreatment. As the pretreatment, a pretreatment for cleaning the surface of the base material or a pretreatment for forming irregularities on the surface is preferable. Only one kind of pretreatment may be performed, or two or more kinds of pretreatments may be performed. As a specific method of the pretreatment, a known method can be used.

The metal member 2 is preferably subjected to at least one treatment selected from the group consisting of a degreasing treatment, a UV ozone treatment, a blasting treatment, a polishing treatment, a plasma treatment, and an etching treatment.

The resin member 5 is preferably subjected to at least one treatment selected from the group consisting of a degreasing treatment, a UV ozone treatment, a blasting treatment, a polishing treatment, a plasma treatment, and a corona discharge treatment.

### Action and Effect

As illustrated in FIG. 4, the action and effect of the bumper reinforcement will be described with reference to an example in which the bumper reinforcement receives a heavy load W in the vehicle front-rear direction. First, a force due to the heavy load W is applied to the front surface portion 250 of the body 200. The force transmits from the front surface portion 250 through the lower portion 230 and the upper portion 240 to the lower first joining portion 210 and the upper first joining portion 220. The body 200 has a hat shape, and thus the force is dispersed and transmitted to the resin reinforcing portion 300 as a force F1 in the vehicle front-rear direction and to the lower first joining portion 210 and the upper first joining portion 220 as outward forces F2 in a direction along the joined surface, in the case of FIG. 4, in the vehicle up-down direction.

The lower second joining portion 310 and the upper second joining portion 320 are joined to the lower first joining portion 210 and the upper first joining portion 220 at joined surfaces intersecting the front-rear direction of the vehicle. In other words, the force F2 is transmitted to the joined surface. The force F2 is smaller than the heavy load W by an amount by which the force F1 is dispersed in the force due to the heavy load W. Thus, the joining strength of the lower second joining portion 310 and the lower first joining portion 210 and the joining strength of the upper second joining portion 320 and the upper first joining portion 220 can be significantly improved as compared with a case where the joined surfaces are provided parallel to the vehicle front-rear direction.

The lower first joining portion 210 and the upper first joining portion 220 are joined to the lower second joining portion 310 and the upper second joining portion 320, respectively, and the lower second joining portion 310 and the upper second joining portion 320 are formed integrally with the resin main body 304. Thus, the resin reinforcing portion 300 exerts a stress against the force F2. In other words, the resin main body 304 exerts a stress against the force F2. Consequently, the resin reinforcing portion 300 suppresses outward deformation of the lower first joining portion 210 and the upper first joining portion 220 of the body 200 in the vehicle up-down direction.

Furthermore, the heavy load W generates a force for bending the bumper reinforcement 400 in the vehicle width direction. The lower second joining portion 310 and the upper second joining portion 320 of the resin reinforcing portion 300 are joined to the lower first joining portion 210 and the upper first joining portion 220 of the body 200 over the entire region in the vehicle width direction, respectively. As a result, the resin reinforcing portion 300 maintains a state of being joined to the body 200, whereby the lower reinforcing rib 330 and the upper reinforcing rib 340 exert a stress against a force of bending in the vehicle width direction. Consequently, the resin reinforcing portion 300 suppresses bending of the body 200 in the vehicle width direction.

Accordingly, the bumper reinforcement 400 can effectively transmit an impact energy that cannot be absorbed to the crash box while absorbing the force generated by the heavy load W by plastic deformation of the body 200 and the resin reinforcing portion 300. As a result, in the vehicle provided with the bumper reinforcement 400, the impact energy caused by the heavy load W is effectively transmitted to the crash box 40, and the impact energy is efficiently absorbed, whereby damage to the vehicle body can be suppressed.

### First Modification: First Modification of Bumper Reinforcement

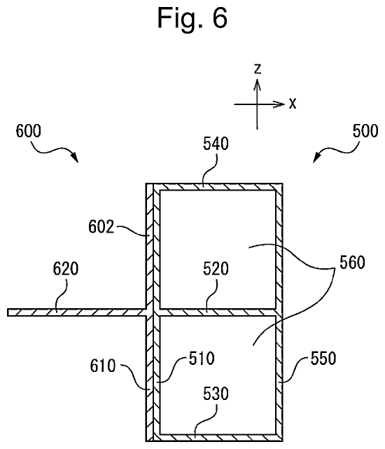

FIG. 6 illustrates a cross-sectional view of a bumper reinforcement according to another embodiment. The bumper reinforcement has a body 500 and a resin reinforcing portion 600. With regard to materials and thicknesses of the body 500 and the resin reinforcing portion 600, an angle of a reinforcing rib 620 in the resin reinforcing portion 600, and the like, those described in the body 200 and the resin reinforcing portion 300 can be similarly employed.

The body 500 is closed on the side opposite to a front surface portion 550, and the closed portion constitutes a first joining portion 510. In other words, the body 500 has a closed cross section and such a body may be referred to as a “closed body” in this disclosure. The resin reinforcing portion 600 includes a resin main body 602 extending along the vehicle width direction and a second joining portion 610. The resin main body 602 has a plate shape with the vehicle width direction as a longitudinal direction, the vehicle up-down direction as a lateral direction, and the vehicle front-rear direction as a thickness direction. The resin main body 602 is integrated with the second joining portion 610. The second joining portion 610 is joined to the first joining portion 510 in a state where the entire surface of the resin main body 602 on the body side is in contact with the first joining portion 510. The second joining portion 610 of the resin reinforcing portion 600 is joined to the first joining portion 510, and one reinforcing rib 620 is formed at a position corresponding to a middle portion 520 of the body 500 and protrudes toward the vehicle body.

### Closed Body

In the closed body 500, two hollow portions 560 are formed with the middle portion 520 as a boundary. The number of hollow portions of the closed body is not particularly limited and can be appropriately selected in consideration of weight reduction, appropriate rigidity, and plastic deformability, but it is preferably formed at two or more positions. For example, in a case where three hollow portions are formed, two middle portions 520 are present.

In FIG. 6, an outer peripheral cross-sectional shape of the body 500 is rectangular. The outer peripheral cross-sectional shape of the closed body is not particularly limited, and may be a polygonal shape, a square shape, a trapezoidal shape, a semicircular shape, or the like.

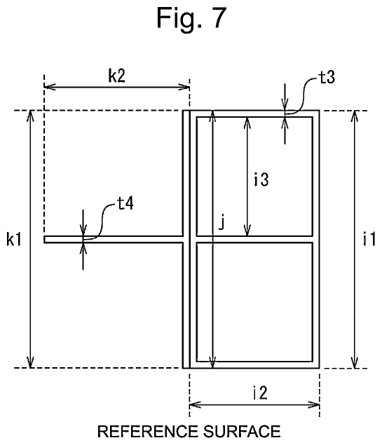

FIG. 7 is a cross-sectional view illustrating dimensions of the body 500 and the resin reinforcing portion 600. The following description using FIG. 7 is not limited to the embodiment in which the cross-sectional shape of the body is as illustrated in FIG. 7.

A height i1 of the front surface portion 550 and a width j of the first joining portion 510 can each independently be 50 mm or more, 60 mm or more, 80 mm or more, or 100 mm or more, and can be 200 mm or less, 180 mm or less, 160 mm or less, or 150 mm or less. The height i1 of the front surface portion 550 and the width j of the first joining portion 510 can be appropriately set in accordance with required performances (joining strength, rigidity, and plastic deformability).

A depth i2 of the body 500 can be 20 mm or more, 30 mm or more, 40 mm or more, or 50 mm or more, and can be 100 mm or less, 90 mm or less, 80 mm or less, or 70 mm or less. The depth i2 of the body 500 can be appropriately set in accordance with required rigidity and plastic deformability.

A height i3 of a hollow 560 can be 20 mm or more, 30 mm or more, 40 mm or more, or 50 mm or more, and can be 100 mm or less, 90 mm or less, 80 mm or less, or 70 mm or less. A height i3 of the hollow 560 can be appropriately set in accordance with the required rigidity and plastic deformability.

A thickness t3 of the body 500 can be in the same range as the thickness t1 of the body 200.

### Resin Reinforcing Portion

In FIG. 6, one reinforcing rib 620 is disposed corresponding to the middle portion 520 of the body 500. The reinforcing rib 620 is preferably disposed corresponding to at least one of the lower portion 530, the middle portion 520, or the upper portion 540 of the body 500. From the viewpoint of appropriate plastic deformability and well-balanced reception of impact, in a case where one reinforcing rib 620 is disposed, the reinforcing rib 620 is preferably disposed corresponding to the position of the middle portion 520, and in a case where two or more reinforcing ribs 620 are disposed, the reinforcing ribs 620 are preferably disposed symmetrically. The reinforcing rib 620 is more preferably disposed in such a manner to coincide with at least one of the lower portion 530, the middle portion 520, or the upper portion 540.

A width of the second joining portion k1 of the resin reinforcing portion 600 (corresponding to the height of the resin reinforcing portion) is in the same range as the width j of the first joining portion 510, and may be different from the width j of the first joining portion 510. A thickness t4 of the resin reinforcing portion 600 can be in the same range as the thickness t2 of the resin reinforcing portion 300. A protrusion amount k2 of the reinforcing rib 620 of the resin reinforcing portion 600 can be set in the same range as the protrusion amounts f1 and f2 of the lower reinforcing rib 330 and the upper reinforcing rib 340 of the resin reinforcing portion 300.

### Second Modification: Second Modification of Bumper Reinforcement

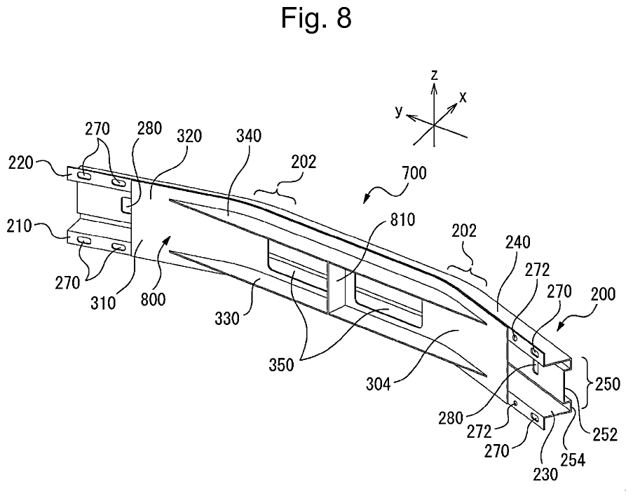

FIG. 8 illustrates a schematic perspective view of a bumper reinforcement 700 according to still another embodiment. The same components as those in the above-described embodiments are denoted by the same reference numerals, and description thereof is omitted. The bumper reinforcement 700 includes a body 200 extending along the vehicle width direction and a resin reinforcing portion 800 extending along the vehicle width direction and disposed closer to the vehicle body than the body 200.

The resin reinforcing portion 800 includes a resin main body 304 extending along the vehicle width direction, a lower second joining portion 310, and an upper second joining portion 320. The resin main body 304 has a plate shape with the vehicle width direction as a longitudinal direction, the vehicle up-down direction as a lateral direction, and the vehicle front-rear direction as a thickness direction, and includes a bent portion 302 at a position corresponding to the bent portion 202 of the body 200. The resin main body 304 integrally includes a lower second joining portion 310 and an upper second joining portion 320 on the lower side and the upper side, respectively.

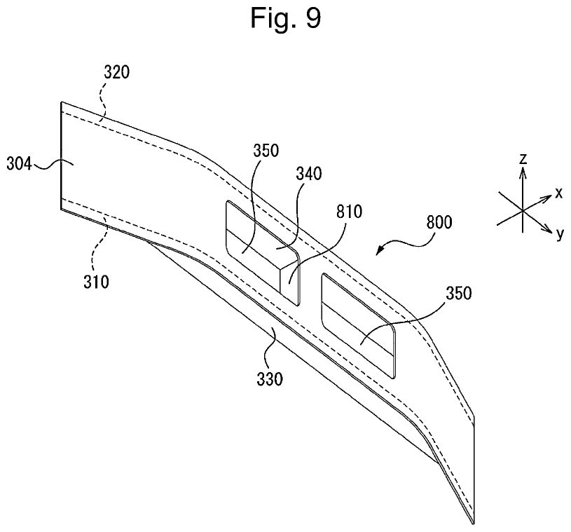

As illustrated in FIG. 9, the lower second joining portion 310 is a strip-shaped region that is disposed on the lower side of the resin main body 304, extends from one end to the other end in the vehicle width direction, and has a predetermined width. The upper second joining portion 320 is a strip-shaped region that is disposed on the upper side of the resin main body 304, extends from one end to the other end in the vehicle width direction, and has a predetermined width. The lower second joining portion 310 and the upper second joining portion 320 are integrated via the resin main body 304. The lower second joining portion 310 and the upper second joining portion 320 are joined to the lower first joining portion 210 and the upper first joining portion 220, respectively, in a state where the surfaces of the lower second joining portion 310 and the upper second joining portion 320 on the body side are in contact with the lower first joining portion 210 and the upper first joining portion 220, respectively.

The resin reinforcing portion 800 has a lower reinforcing rib 330 and an upper reinforcing rib 340 that protrude toward the vehicle body and extend along the vehicle width direction (FIG. 8). Hereinafter, in a case where the lower reinforcing rib 330 and the upper reinforcing rib 340 are not distinguished from each other, they are simply referred to as a reinforcing rib. The reinforcing rib has a plate shape with the vehicle width direction as a longitudinal direction, the vehicle front-rear direction as a lateral direction, and the vehicle up-down direction as a thickness direction. The length of the reinforcing rib in the longitudinal direction is longer than the distance between the bent portions of the resin main body 304, and the front end in the lateral direction has a shape along the vehicle body-side surface of the resin main body 304. The reinforcing rib is integrally connected to the vehicle body-side surface of the resin main body 304 at the front end in the lateral direction. The rear end of the reinforcing rib in the lateral direction has a linear shape substantially parallel to the vehicle width direction.

Furthermore, the resin reinforcing portion 800 includes at least one second reinforcing rib 810 that protrudes toward the vehicle body and extends along the vehicle up-down direction, one second reinforcing rib 810 in the case of FIG. 8. The second reinforcing rib 810 has a plate shape having a surface substantially parallel to the vehicle front-rear direction and the vehicle up-down direction. The second reinforcing rib 810 is preferably disposed at the center of the resin main body 304 in the vehicle width direction. The front end of the second reinforcing rib 810 is integrally connected to the vehicle body-side surface of the resin main body 304. Upper and lower ends of the second reinforcing rib 810 in the vehicle up-down direction are integrally connected to the upper second joining portion 320 and the lower second joining portion 310, respectively.

In the bumper reinforcement 700 according to the present embodiment, the resin reinforcing portion 800 includes the resin main body 304, the lower second joining portion 310, the upper second joining portion 320, the lower reinforcing rib 330, and the upper reinforcing rib 340, whereby the same effects as those of the above-described embodiments can be obtained. Furthermore, the resin reinforcing portion 800 of the present embodiment includes the second reinforcing rib 810, and thus the resin main body 304 exerts a larger stress against the outward force F in the vehicle up-down direction. Accordingly, the resin reinforcing portion 800 more reliably suppresses deformation of the lower first joining portion 210 and the upper first joining portion 220 of the body 200 in directions away from each other in the vehicle up-down direction.

### EXAMPLES

Examples, Comparative Examples, Test Examples, and Comparative Test Examples relating to the present invention will be described below, but the present invention is not limited thereto. In the following Examples, the base material A and the base material B are collectively referred to as a joining base material.

### Joining Base Material

The following joining base materials were used.

### Pa66 (6,6-Nylon)

Amilan (trade name) CM3001G-30 available from Toray Industries, Inc. was injection-molded to obtain a test piece having a width of 10 mm, a length of 45 mm, and a thickness of 3 mm. It was used without surface treatment. To efficiently perform heating at the time of ultrasonic welding, a linear projection having an equilateral triangular cross section and a height of 0.5 mm was formed at a position of 2.5 mm from the end.

### PBT (Polybutylene Terephthalate)

20-1001 available from SABIC was injection-molded to obtain a test piece having a width of 18 mm, a length of 45 mm, and a thickness of 1.5 mm. It was used without surface treatment.

### Aluminum

A surface of A6061-T6 was blasted to obtain a test piece having a width of 10 mm, a length of 45 mm, and a thickness of 3 mm.

### Weight Average Molecular Weights, Heat of Fusion, and Epoxy Equivalents of Thermoplastic Epoxy Resin and Phenoxy Resin

The weight average molecular weight, heat of fusion, and epoxy equivalent of each of the thermoplastic epoxy resin and the phenoxy resin were measured by the following procedures.

### Weight Average Molecular Weight

The thermoplastic epoxy resin and the phenoxy resin were each dissolved in tetrahydrofuran and measurement was performed using Prominence 501 (available from Showa Science Co., Ltd., Detector: Shodex (trade name) RI-501 (available from Showa Denko K.K.)) under the following conditions.
Column: LF-804×2 available from Showa Denko K.K.
Column temperature: 40° C.
Sample: 0.4 mass % resin solution in tetrahydrofuran
Flow rate: 1 mL/min
Eluent: tetrahydrofuran
Calibration method: conversion by standard polystyrene

### Heat of Fusion

The thermoplastic epoxy resin and the phenoxy resin were weighed from 2 to 10 mg, placed in an aluminum pan, and heated from 23° C. to 200° C. at 10° C./min using a DSC (DSC8231 available from Rigaku Corporation) to obtain a DSC curve. The heat of fusion was calculated from an area of an endothermic peak at the time of melting in the obtained DSC curve and the weighed value.

### Epoxy Equivalent

A measured value obtained in accordance with JIS K 7236:2001 was converted into a value as a resin solid content. In a case of a simple mixture without reaction, it was calculated from the epoxy equivalent and content of each mixed component.

### Test Example 1

### Solid Joining Agent P-1

Into a reactor equipped with a stirrer, a reflux condenser, a gas inlet tube, and a thermometer, 203 g (1.0 equivalent) of jER (trade name) 1007 (available from Mitsubishi Chemical Corporation, bisphenol A-type epoxy resin, weight average molecular weight: about 10000), 12.5 g (1.0 equivalent) of bisphenol S, 2.4 g of triphenylphosphine, and 1000 g of methylethylketone were charged, and heated to 100° C. while stirring under a nitrogen gas atmosphere. After visually confirming that they were dissolved, the mixture was cooled to 40° C. to obtain a resin composition having a solid content of about 20 mass %. The solvent was removed from the resin composition to obtain a film-shaped solid joining agent (P-1) having a solid content of 100 mass % and a thickness of 100 μm. The weight average molecular weight was about 37000. The epoxy equivalent was the detection limit or more. No peak of heat of fusion was detected in the DSC.

### Joined Body

A joined body of the base material A (metal member) and the base material B (resin member) listed in Table 1 was prepared. For open time evaluation, a joined body for open time evaluation was also prepared by the same procedure, except that the solid joining agent was placed on the aluminum (base material A) and allowed to stand for 3 days, and then the PBT (base material B) was placed thereon.

The solid joining agent P-1 cut into a size of 10×15 mm was placed on the base material A, and immediately thereafter, the base material B was placed thereon. An overlap between these base materials was set to a width of 10 mm and a depth of 5 mm. The solid joining agent P-1 was disposed so as to cover the entire overlapping region between the base materials. In other words, the base material A and the base material B were not in direct contact with each other, and the solid joining agent was interposed therebetween to prepare an unjoined laminate.

The metal was heated by high-frequency induction using a high-frequency induction welding machine (available from Seidensha Electronics Co., Ltd., Oscillator UH-2.5K, Press JIIP30S), and the test pieces were joined to each other by heating and pressurization. A force for pressurization was 110 N (pressure 2.2 MPa) and an oscillation frequency was 900 kHz. The oscillation time was 6 seconds.

### Test Example 2

### Solid Joining Agent P-2

Into a reactor equipped with a stirrer, a reflux condenser, a gas inlet tube, and a thermometer, 20 g of Enotote (trade name) YP-50S (available from NIPPON STEEL Chemical & Material CO., LTD., phenoxy resin, weight average molecular weight: about 50000) and 80 g of cyclohexanone were charged, and heated to 60° C. while stirring, visually confirmed to be dissolved, and cooled to 40° C. to obtain a resin composition having a solid content of 20 mass %. The solvent was removed from the resin composition to obtain a film-shaped solid joining agent (P-2) having a solid content of 100 mass % and a thickness of 100 μm. The weight average molecular weight was 50000, and the epoxy equivalent was the detection limit or more. No peak of heat of fusion was detected in the DSC.

### Joined Body

A joined body listed in Table 1 and a joined body for open time evaluation were prepared in the same manner as in Test Example 1, except that P-2 was used as the solid joining agent.

### Test Example 3

### Solid Joining Agent P-3

A solid joining agent (P-3) was obtained by mixing the resin composition P-2 and a crystalline epoxy resin YSLV-80XY (available from NIPPON STEEL Chemical & Material CO., LTD.) at a mass ratio of 98:2. The weight average molecular weight was 36000, the epoxy equivalent was 9600 g/eq, and the heat of fusion was 2 J/g.

### Joined Body

A joined body listed in Table 1 and a joined body for open time evaluation were prepared in the same manner as in Test Example 1, except that P-3 was used as the solid joining agent.

### Test Example 4

### Solid Joining Agent P-4

A solid joining agent (P-4) was obtained by mixing the resin composition P-2 and a crystalline epoxy resin YSLV-80XY (available from NIPPON STEEL Chemical & Material CO., LTD.) at a mass ratio of 94:6. The weight average molecular weight was 35000, the epoxy equivalent was 2100 g/eq, and the heat of fusion was 4 J/g.

### Joined Body

A joined body listed in Table 1 and a joined body for open time evaluation were prepared in the same manner as in Test Example 1, except that P-4 was used as the solid joining agent.

### Test Example 5

### Solid Joining Agent P-5

A solid joining agent (P-5) was obtained by mixing the resin composition P-2 and a crystalline epoxy resin YSLV-80XY (available from NIPPON STEEL Chemical & Material CO., LTD.) at a mass ratio of 89:11. The weight average molecular weight was 33000, the epoxy equivalent was 1745 g/eq, and the heat of fusion was 11 J/g.

### Joined Body

A joined body listed in Table 1 and a joined body for open time evaluation were prepared in the same manner as in Test Example 1, except that P-5 was used as the solid joining agent.

### Test Example 6

### Solid Joining Agent P-6

Into a reactor equipped with a stirrer, a reflux condenser, a gas inlet tube, and a thermometer, 203 g (1.0 equivalent) of jER (trade name) 1007 (available from Mitsubishi Chemical Corporation, bisphenol A-type epoxy resin, weight average molecular weight: about 4060), 12.5 g (0.6 equivalents) of bisphenol S (molecular weight: 250), 2.4 g of triphenylphosphine, and 1000 g of methylethylketone were charged, and heated to 100° C. while stirring under a nitrogen gas atmosphere. After visually confirming that they were dissolved, the mixture was cooled to 40° C. to obtain a resin composition having a solid content of about 20 mass %. The solvent was removed from the resin composition to obtain a film-shaped solid joining agent (P-6) having a solid content of 100 mass % and a thickness of 100 μm. The weight average molecular weight was about 30000, and the epoxy equivalent was the detection limit or more. No peak of heat of fusion was detected in the DSC.

### Joined Body

A joined body listed in Table 1 and a joined body for open time evaluation were prepared in the same manner as in Test Example 1, except that P-6 was used as the solid joining agent.

### Comparative Test Example 1

### Solid Joining Agent Q-1

Two liquids of a thermosetting liquid epoxy adhesive E-250 (available from Konishi Co., Ltd., two-liquid type of bisphenol-type epoxy resin and amine curing agent) were mixed, applied to a release film, cured at 100° C. for 1 hour, then cooled, and peeled off from the release film to obtain a 100 μm-thick film-shaped solid joining agent (Q-1). No peak of heat of fusion was detected in the DSC. The solid joining agent was insoluble in the solvent, and thus it was impossible to measure the epoxy equivalent and the weight average molecular weight.

### Joined Body

A joined body listed in Table 1 and a joined body for open time evaluation were prepared in the same manner as in Test Example 1, except that Q-1 was used as the solid joining agent.

### Comparative Test Example 2

### Solid Joining Agent Q-2

An amorphous polycarbonate film (Iupilon (trade name) FE2000, available from Mitsubishi Engineering-Plastics Corporation, 100 μm thick) was used as a solid joining body Q-2. No peak of heat of fusion was detected in the DSC.

### Joined Body

A joined body listed in Table 1 and a joined body for open time evaluation were prepared in the same manner as in Test Example 1, except that Q-2 was used as the solid joining agent.

### Comparative Test Example 3

### Solid Joining Agent Q-3

A crystalline epoxy resin YSLV-80XY (available from NIPPON STEEL Chemical & Material CO., LTD.) was used as a solid joining agent (Q-3). The epoxy equivalent was 192 g/eq. The weight average molecular weight was 340. The heat of fusion was 70 J/g.

### Joined Body

A joined body listed in Table 1 and a joined body for open time evaluation were prepared in the same manner as in Test Example 1, except that Q-3 was used as the solid joining agent.

### Comparative Test Example 4

### Joined Body

Two liquids of a thermosetting liquid epoxy adhesive E-250 (available from Konishi Co., Ltd., two-liquid type including bisphenol-type epoxy resin and amine curing agent) were mixed, and applied to each of the same base material A and base material B as in Test Example 1, and the base materials were bonded to each other within 1 minute. Thereafter, the bonded body was allowed to stand in an oven at 100° C. for 1 hour in a state of being fixed with a clip to cure the adhesive components, and then cooled to room temperature to prepare the joined body listed in Table 1. A joined body for open time evaluation was also prepared in the same manner as described above, except that the thermosetting liquid epoxy adhesive E-250 was applied to each of the base material A and the base material B, and then the base material A and the base material B were allowed to stand for 3 days and then bonded to each other.

### Comparative Test Example 5

Into a flask, 203 g (1.0 equivalent) of jER (trade name) 1007 (available from Mitsubishi Chemical Corporation, bisphenol A-type epoxy resin, weight average molecular weight: about 10000), 12.5 g (1.0 equivalent) of bisphenol S, 2.4 g of triphenylphosphine, and 1000 g of methylethylketone were charged, and stirred at normal temperature to obtain a liquid resin composition having a solid content of about 20 mass %. The liquid resin composition was applied onto the same base material B as in Test Example 1 by bar coating, dried at room temperature for 30 minutes, and then allowed to stand in an oven at 160° C. for 2 hours to form a solid coating layer of a thermoplastic epoxy resin polymer having a thickness of 100 μm on the surface of the base material B. The weight average molecular weight of the coating layer was about 40000. The epoxy equivalent was the detection limit or more. No peak of heat of fusion was detected in the DSC.

### Joined Body

A joined body listed in Table 1 was prepared in the same manner as in Test Example 1, except that the base material A was directly disposed on the base material B having the coating layer. For open time evaluation, a joined body for open time evaluation was also prepared in the same manner as described above, except that a coating layer of a thermoplastic epoxy resin polymer was formed on the surface of the base material B, then allowed to stand for 3 days, and stacked with the base material A.

### Comparative Test Example 6

Into a reactor equipped with a stirrer, a reflux condenser, a gas inlet tube, and a thermometer, 20 g of Phenotote (trade name) YP-50S (available from NIPPON STEEL Chemical & Material CO., LTD., phenoxy resin, weight average molecular weight: about 50000) and 80 g of cyclohexanone were charged, heated to 60° C. while stirring, visually confirmed to be dissolved, and cooled to 40° C. to obtain a liquid resin composition having a solid content of 20 mass %. The liquid resin composition was applied onto the same base material B as in Test Example 1 by bar coating, and was left to stand in an oven at 70° C. for 30 minutes to form a phenoxy resin coating layer having a thickness of 100 μm on the surface of the base material B. The weight average molecular weight of the coating layer was about 50000. The epoxy equivalent was the detection limit or more. No peak of heat of fusion was detected in the DSC.

### Joined Body

A joined body listed in Table 1 was prepared in the same manner as in Test Example 1, except that the base material A was directly disposed on the base material B having the phenoxy resin coating layer. For open time evaluation, a joined body for open time evaluation was also prepared in the same manner as described above, except that the phenoxy resin coating layer was formed on the surface of the base material B, allowed to stand for 3 days, and then stacked with the base material A.

### Comparative Test Example 7

### Joined Body

A joined body listed in Table 1 and a joined body for open time evaluation were prepared in the same manner as in Test Example 1, except that a crystalline polyamide-based hot melt adhesive film NT-120 (available from Nihon Matai Co., Ltd., thickness: 100 μm) was used as the solid joining agent. The heat of fusion was 60 J/g.

### Shear Adhesive Force

The joined bodies obtained in Test Examples 1 to 6 and Comparative Test Examples 1 to 7 were allowed to stand at a measurement temperature (23° C. or 80° C.) for 30 minutes or longer, and then subjected to a tensile shear adhesive strength test in an atmosphere of 23° C. and 80° C. in accordance with ISO19095 using a tensile tester (universal tester autograph “AG-X plus” (available from Shimadzu Corporation); load cell: 10 kN, tensile speed: 10 mm/min) to measure joining strength. The measurement results are listed in Table 1.

### Joining Process Time

The joining process time was measured as follows. The time from a start point to an end point was measured with the time point of contact between at least one of the base materials constituting the joined body and the joining agent as the start point and the time point of completion of preparation of the joined body as the end point. As for heating and pressurization times, the heating and pressurization times of the joined bodies listed in Table 1 were averaged.

### Recyclability

The joined body listed in Table 1 was placed on a hotplate at 200° C. and heated for 1 minute, and then recyclability was judged on the basis of whether the joined body could be easily peeled off with a force of 1 N or less. Recyclability was evaluated as good (OK) when all the joined bodies could be peeled off, and was evaluated as poor (NG) when some joined bodies could not be peeled off.

### Repairability

After the tensile shear strength test at 23° C., among the test pieces of aluminum and iron whose bonding surfaces were fractured (the layer of the joined solid remained on the surface of the base material A or B, or both), the base material A was placed on the base material B and a joined body was prepared in the same manner as in Test Example 1 to obtain a repair joined body. The shear adhesive force of the repair joined body at 23° C. was measured in the same manner as in the test method. When the shear adhesive force was 80% or more of the first shear adhesive force, repairability was evaluated as good (OK), and when the shear adhesive force was less than 80%, repairability was evaluated as unsuitable (NG).

### Open Time Evaluation

The joined body for open time evaluation was used to perform the tensile shear adhesive strength test at 23° C. As compared with the test pieces prepared by the method of Test Examples and Comparative Test Examples, when the shear adhesive force was 80% or more, open time evaluation was determined as good (OK), and when the shear adhesive force was less than 80%, it was determined as unsuitable (NG). The open time evaluation being good (OK) means that the open time is long and convenience is excellent.

TABLE 1-1
Table 1

| | | | Test Example 1 | Test Example 2 | Test Example 3 |
|---|---|---|---|---|---|
| Properties of | | Form of joining agent | Film | Film | Film |
| joining agent | | Resin main component | Thermoplastic | Phenoxy | Thermoplastic |
| | | | epoxy resin | resin | epoxy resin |
| | | Weight average | 37000 | 50000 | 36000 |
| | | molecular weight | | | |
| | | Heat of fusion [J/g] | Fusion peak | Fusion peak | 2 |
| | | | None | None | |
| | | Epoxy equivalent [g/eq] | Detection limit | Detection limit | 9600 |
| | | | or more | or more | |
| Adhesive | 23° C. Shear | Aluminum (base material | 25 | 24 | 20 |
| force | adhesive | A)/PBT (base material B) | | | |
| | force [MPa] | Aluminum (base material | 20 | 15 | 19 |
| | | A)/PA66 (base material B) | | | |
| | 80° C. Shear | Aluminum (base material | 20 | 17 | 17 |
| | adhesive | A)/PBT (base material B) | | | |
| | force [MPa] | Aluminum (base material | 14 | 16 | 15 |
| | | A)/PA66 (base material B) | | | |
| Convenience | Joining process time | | 3.5 seconds | 3.5 seconds | 3.5 seconds |
| | Recyclability | | OK | OK | OK |
| | Repairability | | OK | OK | OK |
| | Open time evaluation | | OK | OK | OK |
| | | | Test Example 4 | Test Example 5 | Test Example 6 |
| Properties of | | Form of joining agent | Film | Film | Film |
| joining agent | | Resin main component | Thermoplastic | Thermoplastic | Thermoplastic |
| | | | epoxy resin | epoxy resin | epoxy resin |
| | | Weight average | 35000 | 33000 | 30000 |
| | | molecular weight | | | |
| | | Heat of fusion [J/g] | 4 | 11 | Fusion peak |
| | | | | | None |
| | | Epoxy equivalent [g/eq] | 2100 | 1745 | Detection limit |
| | | | | | or more |
| Adhesive | 23° C. Shear | Aluminum (base material | 20 | 23 | 18 |
| force | adhesive | A)/PBT (base material B) | | | |
| | force [MPa] | Aluminum (base material | 19 | 20 | 14 |
| | | A)/PA66 (base material B) | | | |
| | 80° C. Shear | Aluminum (base material | 15 | 15 | 13 |
| | adhesive | A)/PBT (base material B) | | | |
| | force [MPa] | Aluminum (base material | 13 | 14 | 12 |
| | | A)/PA66 (base material B) | | | |

| | | | | |
|---|---|---|---|---|
| Convenience | Joining process time | 3.5 seconds | 3.5 seconds | 3.5 seconds |
| | Recyclability | OK | OK | OK |
| | Repairability | OK | OK | OK |
| | Open time evaluation | OK | OK | OK |

TABLE 1-2
(Continuation of Table 1)

| | | | Comparative | Comparative | Comparative | Comparative |
|---|---|---|---|---|---|---|
| | | | Test Example 1 | Test Example 2 | Test Example 3 | Test Example 4 |
| Properties of | | Form of joining agent | Film | Film | Film | Liquid |
| joining agent | | Resin main component | Thermosetting | Polycarbonate | Epoxy resin | Thermosetting |
| | | | epoxy resin | | | epoxy resin |
| | | Weight average | — | — | 340 | — |
| | | molecular weight | | | | |
| | | Heat of fusion [J/g] | Fusion peak | Fusion peak | 70 | Fusion peak |
| | | | None | None | | None |
| | | Epoxy equivalent [g/eq] | — | — | 192 | — |
| Adhesive | 23° C. Shear | Aluminum (base material | 1 | 2 | 0 | 15 |
| force | adhesive | A)/PBT (base material B) | | | | |
| | force [MPa] | Aluminum (base material | 1 | 2 | 0 | 2 |
| | | A)/PA66 (base material B) | | | | |
| | 80° C. Shear | Aluminum (base material | 1 | 1 | 0 | 10 |
| | adhesive | A)/PBT (base material B) | | | | |
| | force [MPa] | Aluminum (base material | 1 | 1 | 0 | 1 |
| | | A)/PA66 (base material B) | | | | |

| | | | | | |
|---|---|---|---|---|---|
| Convenience | Joining process time | 3.5 seconds | 3.5 seconds | 3.5 seconds | 70 min |
| | Recyclability | NG | OK | OK | OK |
| | Repairability | NG | OK | OK | NG |
| | Open time evaluation | NG | OK | OK | NG |

| | | | Comparative | Comparative | Comparative |
|---|---|---|---|---|---|
| | | | Test Example 5 | Test Example 6 | Test Example 7 |
| Properties of | | Form of joining agent | Coating layer | Coating layer | Film |
| joining agent | | Resin main component | Thermosetting | Phenoxy | Polyamide |
| | | | epoxy resin | resin | |
| | | Weight average | 40000 | 50000 | — |
| | | molecular weight | | | |
| | | Heat of fusion [J/g] | Fusion peak | Fusion peak | 60 |
| | | | None | None | |
| | | Epoxy equivalent [g/eq] | Detection limit | Detection limit | — |
| | | | or mom | or more | |
| Adhesive | 23° C. Shear | Aluminum (base material | 29 | 20 | 1 |
| force | adhesive | A)/PBT (base material B) | | | |
| | force [MPa] | Aluminum (base material | 30 | 18 | 1 |
| | | A)/PA66 (base material B) | | | |
| | 80° C. Shear | Aluminum (base material | 19 | 16 | 1 |
| | adhesive | A)/PBT (base material B) | | | |
| | force [MPa] | Aluminum (base material | 19 | 16 | 2 |
| | | A)/PA66 (base material B) | | | |

| | | | | |
|---|---|---|---|---|
| Convenience | Joining process time | 150 min | 32 min | 3.5 seconds |
| | Recyclability | OK | OK | OK |
| | Repairability | OK | OK | OK |
| | Open time evaluation | OK | OK | OK |

### Example 1

### Body Member (Body)

An A6061 alloy billet of an aluminum alloy was hot-extruded to produce an extruded shape having a W-hat open cross-sectional shape as illustrated in FIG. 5, water-quenched immediately after being extruded, artificially aged (200° C.×6 hours), and then cut to a length of 400 mm to prepare a body member to be the body. Here, as illustrated in FIG. 5, the widths a1 and a2 of the first joining portion were 26.3 mm, the heights b1 and b2 of the upper surface and the lower surface were 18 mm, the height c of the front surface portion was 105 mm, the depths d1 and d2 of the upper portion and the lower portion were 57.5 mm, the depth e1 from the upper surface to the central recess and the depth e2 from the lower surface to the central recess were 15 mm, and the thickness t1 was 2.5 mm.

### Resin Reinforcing Member (Resin Reinforcing Portion)

PA66-GF30 (polyamide 66 containing 30 mass % of glass fibers) was used and injection-molded to prepare a resin reinforcing member serving as a resin reinforcing portion having a cross section illustrated in FIG. 5 and a length of 240 mm. Here, as illustrated in FIG. 5, the protrusion amounts f1 and f2 of the reinforcing ribs were 50 mm, the interval g between the two reinforcing ribs was 105 mm, the width of the second joining portion was 26.3 mm, which was equal to the widths a1 and a2 of the first joining portions, and the thickness t2 was 2.5 mm.

The body member and the resin reinforcing member were joined to each other using the body member as the base material A and the resin reinforcing member as the base material B by the procedure described in Test Example 1 using the solid joining agent described in Test Example 1. In this way, a test sample of the bumper reinforcement including the body member and the resin reinforcing member was prepared.

### Example 2

### Body Member (Body)

An A6061 alloy billet of an aluminum alloy was hot-extruded to produce an extruded shape having a closed cross-sectional shape in which two forms having a substantially square shape were coupled similar to the body of the bumper reinforcement as illustrated in FIG. 7, water-quenched immediately after being extruded, artificially aged (200° C.×6 hours), and then cut to a length of 400 mm to prepare a linear body member to be the body. Here, the height i1 was 100 mm, the depth i2 was 60 mm, and the thickness t3 was 2.0 mm as illustrated in FIG. 7.

### Resin Reinforcing Member (Resin Reinforcing Portion)

PA66-GF30 (polyamide 66 containing 30 mass % of glass fibers) was used and injection-molded to prepare a resin reinforcing member serving as a resin reinforcing portion having a cross section illustrated in FIG. 7 and a length of 240 mm. Here, as illustrated in FIG. 7, the width k1 of the second joining portion was 100 mm, the protrusion amount k2 of the reinforcing rib was 50 mm, and the thickness t4 was 2.0 mm.

The body member and the resin reinforcing member were joined in the same manner as in Example 1 to prepare a test sample of the bumper reinforcement including the body member and the resin reinforcing member.

### Example 3

A test sample of a bumper reinforcement including a body member and a resin reinforcing member was prepared in the same manner as in Example 1, except that joining between the body member and the resin reinforcing member was performed using the body member as the base material A and the resin reinforcing member as the base material B and using the solid joining agent described in Test Example 2, by the procedure described in Test Example 2.

### Example 4

A test sample of a bumper reinforcement including a body member and a resin reinforcing member was prepared in the same manner as in Example 1, except that joining between the body member and the resin reinforcing member was performed using the body member as the base material A and the resin reinforcing member as the base material B and using the solid joining agent described in Test Example 3, by the procedure described in Test Example 3.

### Example 5

A test sample of a bumper reinforcement including a body member and a resin reinforcing member was prepared in the same manner as in Example 1, except that joining between the body member and the resin reinforcing member was performed using the body member as the base material A and the resin reinforcing member as the base material B and using the solid joining agent described in Test Example 4, by the procedure described in Test Example 4.

### Example 6

A test sample of a bumper reinforcement including a body member and a resin reinforcing member was prepared in the same manner as in Example 1, except that joining between the body member and the resin reinforcing member was performed using the body member as the base material A and the resin reinforcing member as the base material B and using the solid joining agent described in Test Example 5, by the procedure described in Test Example 5.

### Example 7

A test sample of a bumper reinforcement including a body member and a resin reinforcing member was prepared in the same manner as in Example 1, except that joining between the body member and the resin reinforcing member was performed using the body member as the base material A and the resin reinforcing member as the base material B and using the solid joining agent described in Test Example 6, by the procedure described in Test Example 6.

### Comparative Example 1

A body member was prepared in the same manner as in Example 2, except that the thickness t3 was changed to 2.7 mm. This body member was used as a test sample of Comparative Example 1.

### Comparative Example 2

A body member was prepared in the same manner as in Example 2, except that the thickness t3 was changed to 2.8 mm. This body member was used as a test sample of Comparative Example 2.

### Comparative Example 3

A body member was prepared in the same manner as in Example 2, except that the thickness t3 was changed to 3.3 mm. This body member was used as a test sample of Comparative Example 3.

### Comparative Example 4

The body member of Example 1 was used as a test sample of Comparative Example 4.

### Evaluation

The following evaluations were performed on each test sample. The results are summarized in Table 2.

### Evaluation of Plastic Deformability: Three-Point Bending Compression Test

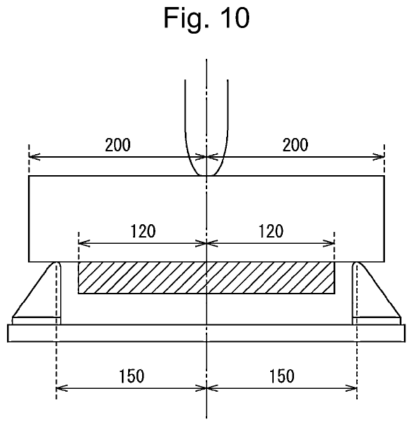

The test was carried out using a three-point bending compression tester configured as illustrated in FIG. 10. Specifically, the test sample was placed in the tester in such a manner that an indenter located above was located at the center of the test sample, and then a load of 5 t or more was applied to the test sample through the indenter at a displacement rate of 1 mm/min in an atmosphere of 25° C. Based on the obtained data, a graph of a load-displacement curve with displacement (mm) on the x-axis and load (t) on the y-axis was created. From this graph, the slope of the initial linear region (between 1 t and 2 t) was determined, a parallel line based on the slope was shifted to the right side, and a displacement amount (residual displacement amount) was determined from the intersection of the x-axis and the parallel line when the load-displacement curve under the 5 t load and the parallel line intersects. Then, a residual strain amount (%) was calculated from the displacement amount based on the following Equation 1. Here, a case where the residual strain amount is 0.20% or more and less than 0.50% can be evaluated as “good”, and a case where the residual strain amount is 0.50% or more can be evaluated as “poor”.

$$Residual strain amount ( \% ) = \qquad Equation 1$$

$$( 6 \times thickness of test sample \times displacement amount ) /$$

$${( inter - fulcrum distance )}^{2}$$

In Equation 1, the inter-fulcrum distance is 300 mm.

### Evaluation of Weight Reduction

As an index of weight reduction, a mass per unit length (g/m) of each test sample was determined. The density of an aluminum alloy (A6061 alloy) constituting the body member is 2.70 g/cm³, and the density of PA66-GF30 constituting the resin reinforcing member is 1.37 g/cm³. When the mass per unit length was less than 2700 g/m, weight reduction was evaluated as “good”, and when the mass per unit length was 2700 g/m or more, weight reduction was evaluated as “poor”.

TABLE 2-1
Table 2

| | Example 1 | Example 2 | Example 3 | Example 4 | Example 5 | Example 6 | Example 7 |
|---|---|---|---|---|---|---|---|
| Type of body member | W-hat type | Closed cross | W-hat type | W-hat type | W-hat type | W-hat type | W-hat type |
| | | section | | | | | |
| Thickness of body member (mm) | 2.5 | 2.0 | 2.5 | 2.5 | 2.5 | 2.5 | 2.5 |
| Thickness of resin reinforcing member (mm) | 2.5 | 2.0 | 2.5 | 2.5 | 2.5 | 2.5 | 2.5 |
| Solid joining agent | 1 | 1 | 2 | 3 | 4 | 5 | 6 |
| Weight per unit length (g/m) | 2628 | 2641 | 2628 | 2628 | 2628 | 2628 | 2628 |
| | (Good) | (Good) | (Good) | (Good) | (Good) | (Good) | (Good) |
| Residual strain (%) | 0.39 | 0.41 | 0.40 | 0.41 | 0.39 | 0.39 | 0.43 |
| | (Good) | (Good) | (Good) | (Good) | (Good) | (Good) | (Good) |

TABLE 2-2

| | Comparative | Comparative | Comparative | Comparative |
|---|---|---|---|---|
| | Example 1 | Example 2 | Example 3 | Example 4 |
| Type of | Closed cross | Closed cross | Closed cross | W-hat |
| body member | section | section | section | type |
| Thickness | 2.7 | 2.8 | 3.3 | 2.5 |
| of body | | | | |
| member (mm) | | | | |
| Thickness | — | — | — | — |
| of resin | | | | |
| reinforcing | | | | |
| member (mm) | | | | |
| Solid | — | — | — | — |
| joining agent | | | | |
| Weight | 2652 | 2746 | 3209 | 1790 |
| per unit | (Good) | (Poor) | (Poor) | (Good) |
| length (g/m) | | | | |
| Residual | 0.50 | 0.49 | 0.42 | 0.56 |
| strain (%) | (Poor) | (Good) | (Good) | (Poor) |

### Results

As can be seen from Table 2, it was confirmed that the configurations of Example 1 to Example 7 including the body member and the resin reinforcing member are excellent in balance between rigidity and plastic deformability while being lightweight.

According to the present invention, it is possible to produce a bumper reinforcement in which a body member and a resin reinforcing member are firmly joined to each other and which is lightweight and excellent in balance between rigidity and plastic deformability in a short joining process time and a long open time.

### INDUSTRIAL APPLICABILITY

The present invention is applicable to a method for producing a bumper reinforcement forming a skeleton of a bumper structure of an automobile.

### REFERENCE SIGNS LIST

2: Metal member
3: Adhesive layer
5: Resin member
10: Bumper fascia
20: Energy absorber
30: Bumper reinforcement
40: Crash box
50: Vehicle body fixing member
100: Bumper structure
200: Body
202: Bent portion
210: Lower first joining portion
220: Upper first joining portion
230: Lower portion
240: Upper portion
250: Front surface portion
252: Central recess
254: Lower surface
256: Upper surface
260: Hollow portion
270: Elongated hole
272: Positioning hole
300: Resin reinforcing portion
302: Bent portion
304: Resin main body
310: Lower second joining portion
320: Upper second joining portion
330: Lower reinforcing rib
340: Upper reinforcing rib
350: Lightening hole
400: Bumper reinforcement
500: Body
510: First joining portion
520: Middle portion
530: Lower portion
540: Upper portion
550: Front surface portion
560: Hollow portion
600: Resin reinforcing portion
602: Resin main body
610: Second joining portion
620: Reinforcing rib
700: Bumper reinforcement
800: Resin reinforcing portion
810: Second reinforcing rib
a1: Width of upper first joining portion
a2: Width of lower first joining portion
b1: Height of upper surface
b2: Height of lower surface
c: Height of front surface portion
d1: Depth of upper portion
d2: Depth of lower portion
e1: Depth from upper surface to central recess
e2: Depth from lower surface to central recess
f1: Protrusion amount of upper reinforcing rib
f2: Protrusion amount of lower reinforcing rib
g: Distance between upper reinforcing rib and lower reinforcing rib
h1: Width of upper second joining portion
h2: Width of lower second joining portion
i1: Height of front surface portion
i2: Depth of body
i3: Height of hollow
j: Width of first joining portion
k1: Width of second joining portion
k2: Protrusion amount of reinforcing rib
t1: Thickness of body
t2: Thickness of resin reinforcing portion
t3: Thickness of body
t4: Thickness of resin reinforcing portion
α1: Angle formed by upper portion and upper first joining portion
α2: Angle formed by lower portion and lower first joining portion
β1: Angle formed by upper surface and upper portion
β2: Angle formed by lower surface and lower portion
γ1: Angle formed by upper second joining portion and upper reinforcing rib
γ2: Angle formed by lower second joining portion and lower reinforcing rib

1: A method for producing a bumper reinforcement, the method comprising:
a pre-joining process of preparing a laminate in a state in which a metal member, a solid joining agent containing, as a main component, an amorphous thermoplastic resin which is at least one of a thermoplastic epoxy resin or a phenoxy resin, and a resin member to be joined to the metal member are arranged in this order; and
a joining process of melting the solid joining agent by heating and pressurizing the laminate to join the metal member and the resin member, wherein
the metal member is a body extending along a vehicle width direction and including at least one first joining portion on a vehicle body side,
the resin member is a resin reinforcing portion extending along the vehicle width direction and including at least one second joining portion,
the first joining portion of the body and the second joining portion of the resin member are joined to each other via the solid joining agent,
the resin reinforcing portion is disposed closer to a vehicle body than the body,
the resin reinforcing portion includes one or more reinforcing ribs that protrude toward the vehicle body and extend along the vehicle width direction, and
the amorphous thermoplastic resin has an epoxy equivalent of 1600 or more, or contains no epoxy group, and the amorphous thermoplastic resin has a heat of fusion of 15 J/g or less.

2: The method for producing a bumper reinforcement according to claim 1, wherein the heating and pressurizing are performed under conditions of 100 to 400° C. and 0.01 to 20 MPa.

3: The method for producing a bumper reinforcement according to claim 1, wherein the solid joining agent before melting has a shape selected from the group consisting of a film, a rod, a pellet, and a powder.

4: The method for producing a bumper reinforcement according to claim 1, wherein the body has an open cross section, and the first joining portion of the body and the second joining portion of the resin reinforcing portion are joined to each other to form a hollow portion inside the body.

5: The method for producing a bumper reinforcement according to claim 1, wherein a cross-sectional shape of the body is a hat form.

6: The method for producing a bumper reinforcement according to claim 1, wherein the body includes the first joining portion on each of upper and lower sides of the body, and the reinforcing rib is disposed corresponding to the first joining portion.

7: The method for producing a bumper reinforcement according to claim 1, wherein the resin reinforcing portion includes one or more holes.

8: The method for producing a bumper reinforcement according to claim 1, wherein the body includes an aluminum alloy having a tensile strength of 350 MPa or higher.

9: The method for producing a bumper reinforcement according to claim 1, wherein the resin reinforcing portion includes a resin having an elastic modulus of 5 GPa or more at 80° C.

10: The method for producing a bumper reinforcement according to claim 1, wherein
the body includes the first joining portion on each of upper and lower sides of the body, and
the resin reinforcing portion includes
a resin main body extending in the vehicle width direction, and
the second joining portion on each of upper and lower sides of the resin main body, and
the first joining portion and the second joining portion are joined at a joined surface that intersects a vehicle front-rear direction.

11: The method for producing a bumper reinforcement according to claim 1, wherein the resin reinforcing portion includes a second reinforcing rib extending in a vehicle up-down direction.
